(19) United States
(12) Patent Application Publication
(10) Pub. No.: US 2015/0125032 A1
(43) Pub. Date: May 7, 2015

(54) OBJECT DETECTION DEVICE

(71) Applicant: PANASONIC INTELLECTUAL PROPERTY MANAGEMENT CO., LTD., Osaka (JP)

(72) Inventors: Mutsuhiro Yamanaka, Osaka (JP); Atsuyuki Hirono, Hyogo (JP); Toshiharu Takenouchi, Osaka (JP); Hiroshi Matsuda, Osaka (JP); Yuichi Yoshimura, Osaka (JP)

(21) Appl. No.: 14/407,929

(22) PCT Filed: Jun. 11, 2013
(86) PCT No.: PCT/JP2013/003652

§ 371 Date: Dec. 12, 2014

(30) Foreign Application Priority Data
Jun. 13, 2012 (JP) 2012-134146
Sep. 27, 2012 (JP) 2012-214612
May 10, 2013 (JP) 2013-100524

(51) Int. Cl. G06K 9/00; G06K 9/62

(52) U.S. Cl. CPC G06K 9/00624; G06K 9/6202
USPC 382/103

(57) ABSTRACT

The object detection device according to the present invention includes: an image obtainer configured to obtain, from a camera for taking images of a predetermined image sensed area, the images of the predetermined image sensed area at a predetermined time interval sequentially; a difference image creator configured to calculate a difference image between images obtained sequentially by the image obtainer; and a determiner configured to determine whether each of a plurality of blocks obtained by dividing the difference image in a horizontal direction and a vertical direction is a motion region in which a detection target in motion is present or a rest region in which an object at rest is present. The determiner is configured to determine, with regard to each of the plurality of blocks, whether a block is the motion region or the rest region, based on pixel values of a plurality of pixels constituting this block.

### TECHNICAL FIELD

The present invention relates to object detection devices.

### BACKGROUND ART

In the past, there has been proposed a moving object detection device (e.g., see document 1 [JP 6-201715 A]). Such a moving object detection device imports two images consecutive in time, and differentiates the two images, and compares the differentiated two images to obtain a difference image, and detects a moving object from this difference image.

With regard to the object detection device of document 1 described above, in a case where a person as the detection object wears clothes whose color similar to a background part, it is considered that a difference in luminance between the person as the detection object and the background part is small. Therefore, in a case of detecting an edge by differentiating monochrome images, an edge of the person is hard to become continuous line, and thus such an edge may be detected as separate parts. Consequently, it is necessary to perform a process of connecting such separate parts, and therefore there may be problems that a throughput of image processing increases and a process of unifying the separated parts without errors is difficult.

Further, there has been proposed a background differencing technique as a method for detecting a detection target such as a person from a monochrome image. The background differencing techniques includes creating a difference image between a monochrome image and a background image to detect a part of the monochrome image which shows a change from the background image. In this background differencing technique, a difference between two monochrome images is calculated for each pixel. Hence, in a case where a person as the detection object wears clothes whose color similar to a background part, a difference between a monochrome image to be compared and the background image may become small. As a result, an entire body of a person may be hard to be detected as a single region, and like the aforementioned example, the human body is likely to be detected as separated parts. Consequently, it is necessary to perform a process of connecting such separate parts, and therefore there may be problems that a throughput of image processing increases and a process of unifying the separated parts without errors is difficult.

In view of this, there has been proposed a motion detection device (e.g., see document 2 [JP 2008-257626 A]). Such a motion detection device divides two image frames into m sections in a horizontal direction and n sections in a vertical direction to generate two sets of blocks, and compares blocks at the same position to determine whether the blocks show motion.

This motion detection device selects a desired background frame and a motion detection target frame subsequent to this background frame from image frames inputted sequentially, and divides the desired background frame and the detection target frame each into m sections in the horizontal direction and n sections in the vertical direction to generate two sets of a plurality of blocks, and calculates a luminance average of pixels for each block. Thereafter, the motion detection device calculates a difference in the luminance average between a block of the motion detection target frame and the corresponding block of the background frame. When the difference is equal to or more than a predetermined threshold, the motion detection device determines that motion occurs at this block.

The aforementioned motion detection device compares the luminance averages of the blocks at the same position with regard to the background frame and the motion detection target frame, and when the luminance average changes by the threshold or more, determines that motion occurs at the block.

In this regard, it is assumed that one block is a region of 4×4 pixels and a block C1 of the background frame and a block C2 of the motion detection target frame have different pixel values as shown in FIG. 39 and FIG. 40. Squares of each of blocks C1 and C2 represent pixels, and numerical numbers inside the squares represent pixel values of the corresponding pixels. In the examples shown in FIG. 39 and FIG. 40, the pixel values of the pixels change between the background frame and the motion detection target frame, and nevertheless the background frame and the motion detection target frame have the same luminance average. Therefore it is determined that there is no motion between these two frames.

Further, it is assumed that only one pixel of one of a block C3 of the background frame and a block C4 of the motion detection target frame has a different value from the other due to an unwanted effect such as noise, as shown in FIG. 41 and FIG. 42. In this case, the pixels other than one pixel of one of the blocks C3 and C4 have the same luminance value as those of the other, and nevertheless the blocks C3 and C4 have different luminance averages. Hence, it is determined that there is motion between the two frames.

### SUMMARY OF INVENTION

In view of the above insufficiency, the present invention has aimed to propose an object detection device capable of successfully discriminating between the motion region and the rest region without increasing a throughput of image processing.

The object detection device of the first aspect in accordance with the present invention includes: an image obtainer configured to obtain, from a camera for taking images of a predetermined image sensed area, the images of the predetermined image sensed area at a predetermined time interval sequentially; a difference image creator configured to calculate a difference image between images obtained sequentially by the image obtainer; and a determiner configured to determine whether each of a plurality of blocks obtained by dividing the difference image in a horizontal direction and a vertical direction is a motion region in which a detection target in motion is present or a rest region in which an object at rest is present. The determiner is configured to determine, with regard to each of the plurality of blocks, whether a block is the motion region or the rest region, based on pixel values of a plurality of pixels constituting this block.

In the object detection device of the second aspect in accordance with the present invention, realized in combination with the first aspect, the determiner is configured to compare, with regard to each of the plurality of blocks, difference values of pixels constituting a block with a predetermined threshold, and determine whether this block is the motion region or the rest region, based on the number of pixels whose difference values exceed the predetermined threshold.

In the object detection device of the third aspect in accordance with the present invention, realized in combination with the first or second aspect, the object detection device further includes an object detector configured to detect a detection target from a region determined as the motion region. The object detector is configured to determine, as a detection target region, each of consecutive blocks of one or more blocks determined as the motion region. The object detector is configured to, when a currently obtained detection target region is included in a previously obtained detection target region, or when the currently obtained detection target region and the previously obtained detection target region overlap each other and a ratio of an area of the currently obtained detection target region to an area of the previously obtained detection target region is smaller than a predetermined threshold, or when there is no overlap between the currently obtained detection target region and the previously obtained detection target region, determine that the detection target is at rest and then regard the previously obtained detection target region as a region in which the detection target is present.

In the object detection device of the fourth aspect in accordance with the present invention, realized in combination with the third aspect, the object detector is configured to, when the currently obtained detection target region and the previously obtained detection target region overlap each other, determine that the same detection target is present in the currently obtained detection target region and the previously obtained detection target region. The object detector is configured to change a determination condition for determining a current location of the detection target from the currently obtained detection target region and the previously obtained detection target region, in accordance with whether the detection target present in the previously obtained detection target region is at rest, or a parameter indicative of a movement of the detection target when it is determined that the detection target is not at rest.

In the object detection device of the fifth aspect in accordance with the present invention, realized in combination with the third or fourth aspect, the object detector is configured to, when a previous first detection target region and a current detection target region overlap each other but there is no overlap between the current detection target region and a previous second detection target region, determine that a detection target present in the first detection target region has moved to the current detection target region.

In the object detection device of the sixth aspect in accordance with the present invention, realized in combination with any one of the third to fifth aspects, the object detector is configured to, when a current detection target region overlaps a previous first detection target region and a previous second detection target region and it is determined that a detection target present in the first detection target region is at rest, determine that the detection target present in the first detection target region stays in the first detection target region.

In the object detection device of the seventh aspect in accordance with the present invention, realized in combination with any one of the third to sixth aspects, the object detector is configured to, when a current detection target region overlaps a previous first detection target region and a previous second detection target region and it is determined that both a first detection target present in the first detection target region and a second detection target present in the second detection target region are in motion and when a speed of the first detection target is more than a speed of the second detection target, determine that the first detection target has moved to the current detection target region. The object detector is configured to, when a current detection target region overlaps a previous first detection target region and a previous second detection target region and it is determined that both a first detection target present in the first detection target region and a second detection target present in the second detection target region are in motion and when a speed of the first detection target is equal to or less than a speed of the second detection target, determine that the first detection target has remained in the first detection target region.

In the object detection device of the eighth aspect in accordance with the present invention, realized in combination with any one of the third to seventh aspects, the object detector is configured to, when a current detection target region overlaps a previous first detection target region and a previous second detection target region and it is determined that a first detection target present in the first detection target region is in motion and a second detection target present in the second detection target region is at rest, determine that the first detection target has moved to the current detection target region.

In the object detection device of the ninth aspect in accordance with the present invention, realized in combination with any one of the third to eighth aspects, the object detector is configured to, when it is determined that a detection target present in a first detection target region obtained at a certain timing is at rest and at least part of a second detection target region obtained after the certain timing overlaps the first detection target region, store, as a template image, an image of the first detection target region obtained immediately before overlapping of the second detection target region. The object detector is configured to, at a timing when an overlap between the first detection target region and the second detection target region disappears, perform a matching process between an image of the first detection target region at this timing and the template image to calculate a correlation value between them. The object detector is configured to, when the correlation value is larger than a predetermined determination value, determine that the detection target has remained in the first detection target region. The object detector is configured to, when the correlation value is smaller than the determination value, determine that the detection target has moved outside the first detection target region.

In the object detection device of the tenth aspect in accordance with the present invention, realized in combination with any one of the first to ninth aspects, the object detection device further includes an image sensing device serving as the camera. The image sensing device includes an image sensor, a light controller, an image generator, and an adjuster. The image sensor includes a plurality of pixels each to store electric charges and is configured to convert amounts of electric charges stored in the plurality of pixels into pixel values and output the pixel values. The light controller is configured to control an amount of light to be subjected to photoelectric conversion by the image sensor. The image generator is configured to read out the pixel values from the image sensor at a predetermined frame rate and generate an image at the frame rate from the read-out pixel values. The adjuster is configured to evaluate some or all of the pixel values of the image generated at the frame rate by an evaluation value defined as a numerical value and adjust the pixel values by controlling at least one of the light controller and the image generator so that the evaluation value falls within a predetermined appropriate range. The adjuster is configured to, when the evaluation value of the image generated at the frame rate is deviated from the appropriate range by a predetermined level or more, set the image generator to an adjusting mode of generating an image at an adjustment frame rate higher than the frame rate, and after the image generator generates the image at the adjustment frame rate, set the image generator to a normal mode of generating the image at the frame rate.

In the object detection device of the eleventh aspect in accordance with the present invention, realized in combination with any one of the first to ninth aspects, the object detection device further includes an image sensing device serving as the camera. The image sensing device includes an image sensing unit, an exposure adjuster, an amplifier, and a controller. The image sensing unit is configured to take an image of an image sensed area at a predetermined frame rate. The exposure adjuster is configured to adjust an exposure condition for the image sensing unit. The amplifier is configured to amplify luminance values of individual pixels of image data outputted from the image sensing unit and output the resultant luminance values. The controller is configured to adjust at least one of the exposure condition of the exposure adjuster and an amplification factor of the amplifier so that a luminance evaluation value calculated by statistical processing on the luminance values of the individual pixels of the image data is equal to a predetermined intended value. The controller is configured to, when the luminance evaluation value falls within a luminance range in which image processing on image data outputted from the amplifier is possible, limit an amount of adjustment so that a ratio of change in the luminance evaluation value caused by adjustment of at least one of the exposure condition and the amplification factor is equal to or less than a predetermined reference value, and is configured to, when the luminance evaluation value is out of the luminance range, not limit the amount of adjustment.

### BRIEF DESCRIPTION OF THE DRAWINGS

FIG. 1 is a block diagram of an object detection device of the embodiment 1.

FIG. 2 is a flow chart illustrating an operation of the object detection device of the embodiment 1.

FIG. 3 is an explanatory diagram illustrating the operation of the object detection device of the embodiment 1.

FIG. 4 is an explanatory diagram illustrating the operation of the object detection device of the embodiment 1.

FIG. 5 is an explanatory diagram illustrating the operation of the object detection device of the embodiment 1.

FIG. 6 is an explanatory diagram illustrating a tracking operation of the object detection device of the embodiment 1.

FIG. 7 is an explanatory diagram illustrating the tracking operation of the object detection device of the embodiment 1.

FIG. 8 is an explanatory diagram illustrating the tracking operation of the object detection device of the embodiment 1.

FIG. 9 is an explanatory diagram illustrating the tracking operation of the object detection device of the embodiment 1.

FIG. 10 is an explanatory diagram illustrating the tracking operation of the object detection device of the embodiment 1.

FIG. 11 is an explanatory diagram illustrating the tracking operation of the object detection device of the embodiment 1.

FIG. 12 is an explanatory diagram illustrating an example of installation of a camera with regard to the object detection device of the embodiment 1.

FIG. 13 is an example of an image in a case of using a narrow-angle lens in the object detection device of the embodiment 1.

FIG. 14 is an example of an image in a case of using a wide-angle lens in the object detection device of the embodiment 1.

FIG. 15 is an explanatory diagram illustrating an image taken by a camera mounted on a wall in the object detection device of the embodiment 1.

FIG. 16 is an explanatory diagram illustrating sizes of blocks.

FIG. 17 is an explanatory diagram illustrating sizes of blocks.

FIG. 18 is a block diagram illustrating an image sensing device in the embodiment 2.

FIG. 19 is an explanatory diagram illustrating changing of frame rates.

FIG. 20 is an explanatory diagram illustrating an operation of the image sensing device in the embodiment 2.

FIG. 21 is an explanatory diagram illustrating the operation of the image sensing device in the embodiment 2.

FIG. 22 is an explanatory diagram illustrating the operation of the image sensing device in the embodiment 2.

FIG. 23 is an explanatory diagram illustrating the operation of the image sensing device in the embodiment 2.

FIG. 24 is an explanatory diagram illustrating the operation of the image sensing device in the embodiment 2.

FIG. 25 is an explanatory diagram illustrating the operation of the image sensing device in the embodiment 2.

FIG. 26 is an explanatory diagram illustrating the operation of the image sensing device in the embodiment 2.

FIG. 27 is a block diagram illustrating a lighting control system of the embodiment 3.

FIG. 28 is a flow chart of the lighting control system of the embodiment 3.

FIG. 29 is a diagram illustrating an adjustment operation of the lighting control system of the embodiment 3.

FIG. 30 is a diagram illustrating the adjustment operation of the lighting control system of the embodiment 3.

FIG. 31 is a diagram illustrating the adjustment operation of the lighting control system of the embodiment 3.

FIG. 32 is a diagram illustrating the adjustment operation of the lighting control system of the embodiment 3.

FIG. 33 is a diagram illustrating the adjustment operation of the lighting control system of the embodiment 3.

FIG. 34 is a diagram illustrating the adjustment operation of the lighting control system of the embodiment 3.

FIG. 35 is a diagram illustrating the adjustment operation of the lighting control system of the embodiment 3.

FIG. 36 is a block diagram illustrating a motion sensor of the embodiment 4.

FIG. 37 is a configuration diagram illustrating a load control system of the embodiment 4.

FIG. 38 is an explanatory diagram of a detection region in the embodiment 4.

FIG. 39 is a diagram illustrating pixel values of blocks of a background frame.

FIG. 40 is a diagram illustrating pixel values of blocks of a frame to be subjected to motion detection.

FIG. 41 is a diagram illustrating pixel values of blocks of the background frame.

FIG. 42 is a diagram illustrating pixel values of blocks of the frame to be subjected to motion detection.

### DESCRIPTION OF EMBODIMENTS

### Embodiment 1

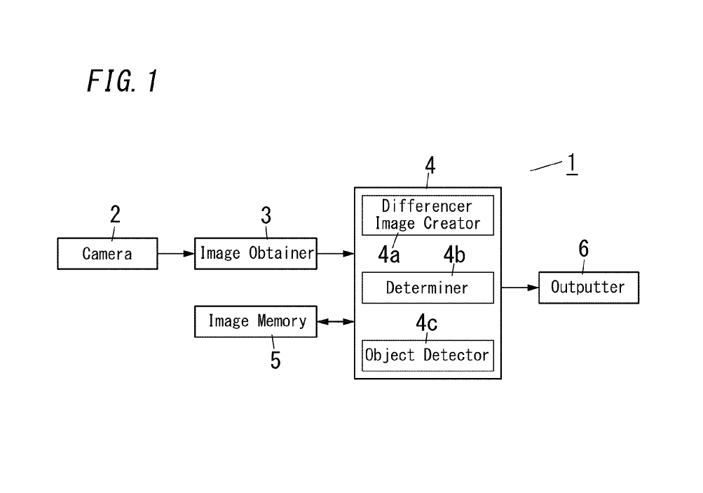

FIG. 1 shows a block diagram of an object detection device 1. The object detection device 1 includes a camera 2, an image obtainer 3, a processor 4, an image memory 5, and an outputter 6, and outputs a detection signal from the outputter 6 in response to detection of a human body which is a detection target (object to be detected). Note that, the detection target of the object detection device 1 is not limited to a human body, and may be a moving object such as a vehicle. Note that, in the present embodiment, the object detection device 1 need not necessarily include the camera 2. The image obtainer 3, the processor 4, the image memory 5, and the outputter 6 constitute an image processing device for processing an image from the camera 2.

The camera 2 is, for example, a CCD camera or a CMOS image sensor. The camera 2 is configured to take an image of a predetermined monitored area.

The image obtainer 3 is configured to import image data from the camera 2 at a predetermined sampling interval, and output the imported image data to the processor 4. In other words, the image obtainer 3 is configured to obtain, from the camera 2 for taking images of a predetermined image sensed area, images of the predetermined image sensed area at a predetermined time interval (sampling interval) sequentially.

The processor 4 is constituted by a microcomputer, and is configured to perform embedded programs to function as a difference image creator 4a, a determiner 4b, an object detector 4c, and the like.

The difference image creator 4a is configured to create (calculate) a difference image between images obtained consecutively by the image obtainer 3.

The determiner 4b is configured to determine whether each of a plurality of blocks obtained by dividing the difference image in a horizontal direction and a vertical direction is a motion region in which a detection target in motion is present or a rest region in which an object at rest is present.

The object detector 4c is configured to detect the detection target from a region determined as the motion region.

Writing data on or reading data from the image memory 5 is controlled by the processor 4. For example, the image memory 5 is configured to store image data imported by the image obtainer 3 from the camera 2 and other image data such as difference images created in a process of image processing, for example.

The outputter 6 is configured to receive the detection signal from the processor 4 and output the received detection signal to a load device (not shown) to operate the load device and/or output the received detection signal to an upper monitoring device (not shown).

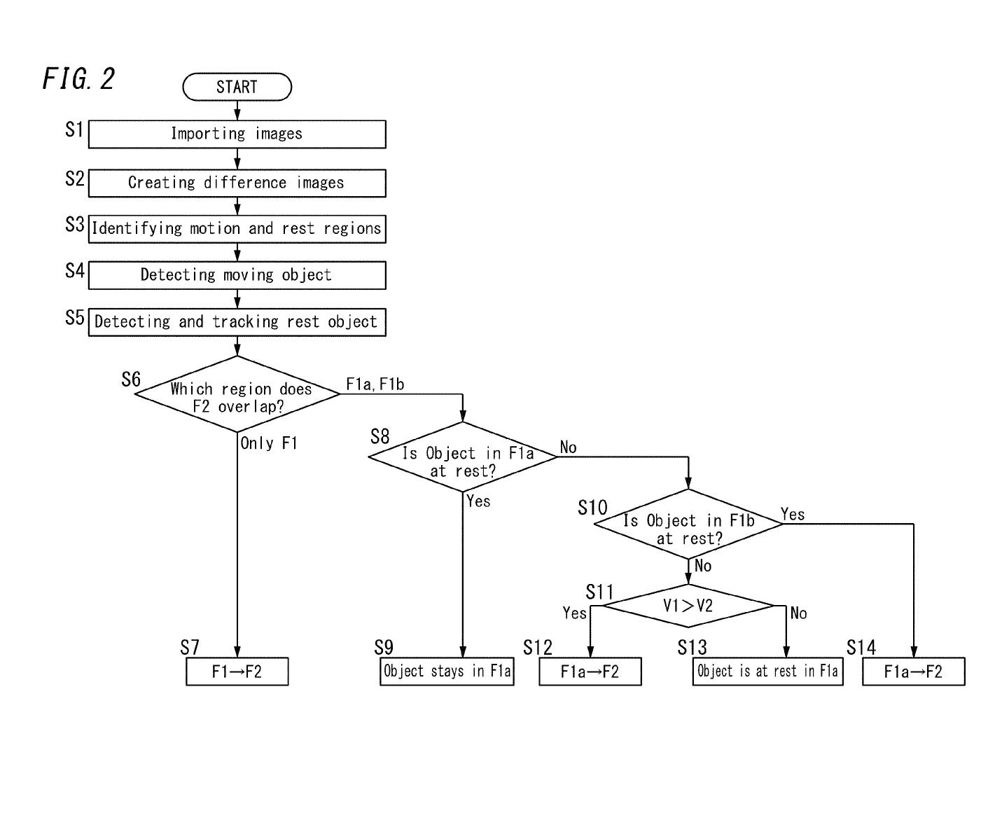

This object detection device 1 detects an object selected as the detection target, from a monochrome image obtained by taking images of the predetermined monitored area by the camera 2. Such a detection operation is described with reference to a flow chart of FIG. 2.

The image obtainer 3 obtains the image data at a predetermined time interval, and outputs the image data obtained from the camera 2 to the processor 4 (step S1).

The processor 4 successively stores series of image data of monochrome images received from the image obtainer 3 in the image memory 5. When the image obtainer 3 obtains a new monochrome image, the difference image creator 4a imports the previous monochrome image from the image memory 5, and creates a difference image between the previous monochrome image and the monochrome image currently obtained by the image obtainer 3 (step S2).

Note that, in the present embodiment, the interframe difference image is created at a predetermined time interval. However, a time interval for a difference between frames need not necessarily be constant. The difference image creator 4a may calculate an interframe difference between two monochrome images taken in time series.

Subsequently, the determiner 4b divides the difference image obtained in step S2 in a horizontal direction and a vertical direction to generate blocks with a predetermined size, and determines whether each block is the motion region or the rest region (step S3).

Note that, the motion region means a region in which a detection target in motion (moving object) is present. The rest region means a region in which an object at rest (rest object) is present.

As described above, a set of steps S1, S2, and S3 is a step of creating, from N monochrome images, (N−1) interframe difference images and determining by use of the (N−1) interframe difference images whether each block is the motion region or the rest region.

Thereafter, the object detector 4c performs a process (steps S4 to S14) of detecting an object selected as the detection target based on a determination result of the determiner 4b. Note that, step S4 is a step of extracting a detection target region in which a moving object is present. For example, consecutive blocks of one or more blocks determined as the motion region are extracted as a single detection target region. Step S5 is a step of extracting and tracking the rest object. Further, a set of steps S6 to S14 is a step of performing a process of tracking a moving object.

The following explanation referring to drawings is made to a process in step S3 in which the determiner 4b determines whether each of a plurality of blocks obtained by dividing the difference image created in step S2 in a horizontal direction and a vertical direction is the motion region or the rest region.

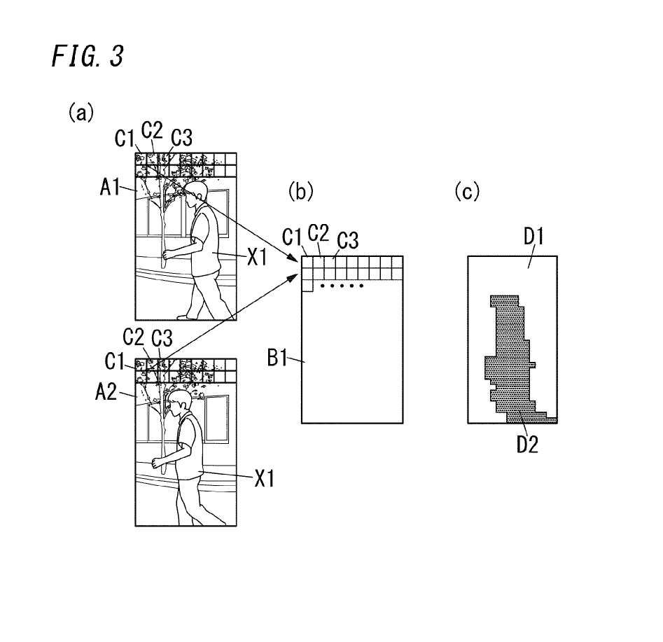

The image obtainer 3 imports the image data from the camera 2 at the predetermined time interval (frame rate). FIG. 3 (a) is an explanatory view illustrating monochrome images imported from a camera. FIG. 3 (b) is an explanatory view illustrating a difference image created from the monochrome images. FIG. 3 (c) is an explanatory view illustrating the determination result of determination of the motion region and the rest region. As shown in FIG. 3 (a), the monochrome image A1 is imported at time (t−2), and thereafter the other monochrome image A2 is imported at time (t−1), and then the difference image creator 4a creates the difference image B1 of the two monochrome images A1 and A2 taken successively. Note that, a person X1 in motion is shown in the two monochrome images A1 and A2.

When the difference image B1 is created by the difference image creator 4a, the determiner 4b divides this difference image B1 in the horizontal direction and the vertical direction to create blocks C1, C2, C3, . . . , of a predetermined size (m×n pixels) (see FIG. 3 (b)). Note that, in the following explanation, when referring to individual blocks, the blocks are represented as blocks C1, C2, C3, . . . , and, when not referring to individual blocks, the blocks are represented as blocks C.

For example, the size of the difference image B1 is 300 pixels in the horizontal direction and 240 pixels in the vertical direction. When the difference image B1 is divided into 40 equal blocks in the horizontal direction and 30 equal blocks in the vertical direction, total of 1200 blocks C of 8×8 pixels are created. The determiner 4b determines whether each block C is the motion region or the rest region.

In this regard, each block C is constituted by 64 (=8×8) pixels. The determiner 4b treats a set of difference values of each block C as a point in a sixty-four dimension space. The determiner 4b performs learning in a conventional method such as a discriminant analysis and an SVM (support vector machine) based on preliminarily prepared learning data (data on the motion region and the rest region). Thereby, the determiner 4b preliminarily calculates a boundary plane dividing the sixty-four dimension space into a space (motion space) in which a detection target in motion is present and a space (rest space) in which an object at rest is present.

Thereafter, when data on a block C is actually inputted into the determiner 4b, the determiner 4b determines whether the block C is the motion region or the rest region, by judging whether this data exists on the motion region side or the rest region side with regard to the above boundary plane in the sixty-four dimension space.

FIG. 3 (c) shows a result of determination of whether each block is the motion region or the rest region. Regions corresponding to the detection target X1 are the motion region D1, and other regions are the rest region D2.

Note that, the determiner 4b may use the (N−1) difference images created from the N (N is an integer of 2 or more) monochrome images taken successively to determine whether a block C of (m×n) pixels at the same position with regard to the (N−1) difference images is the motion region or the rest region.

In this case, the determiner 4b treats a set of difference values of the blocks C at the same position with regard to the (N−1) difference images as a point in a [(N−1)×m×n] dimension space. For example, when there are four difference images and the size of the block C is 8×8 pixels, the set of difference values is treated as a point in 256 (=4×8×8) dimension space. Thereby, in a similar manner to the above, the determiner 4b performs learning in a method such as a discriminant analysis and an SVM based on preliminarily prepared learning data to preliminarily calculate the boundary plane dividing the [(N−1)×m×n] dimension space into the motion space and the rest space.

Thereafter, when the (N−1) difference images are created based on the N monochrome images successively taken, the determiner 4b divides each of the (N−1) difference images into a plurality of blocks C. The determiner 4b treats a set of difference values of the blocks C at the same position with regard to the (N−1) difference images as a point in a [(N−1)×m×n] dimension space, and determines whether this point exists on the motion region side or the rest region side with regard to the above boundary plane in the [(N−1)×m×n] dimension space.

Further in the above explanation, the determination method using means such as the discriminant analysis and the SVM is described. However, the determiner 4b may determine whether the block is the motion region or the rest region by use of a principle component analysis. The determiner 4b treats a set of difference values of a block C of (m×n) pixels as a point in a (m×n) dimension space. Further, the determiner 4b preliminarily calculates principle component coefficients for determining whether each block C is the motion region or the rest region, and thresholds of principle component scores Z, based on preliminarily prepared learning data (data on blocks C determined as the motion region and other blocks C determined as the rest region). For example, when the size of the block is 8×8 pixels, a set of difference values of each block C is treated as a point in a 64 dimension space. For example, when data on the difference image is inputted into the determiner 4b, the determiner 4b calculates the principle component score Z for each block by use of a formula of Z=a1×b1+a2×b2+a3×b3+, . . . , +a64×b64. In this regard, a1, a2, a3, . . . , a64 are the principle component coefficients calculated by the principle component analysis, and b1, b2, b3, . . . , b64 are pixel values of sixty-four pixels constituting a block C. Thereafter, the determiner 4b compares the principle component score Z calculated from the actual difference image with a predetermined threshold to determine whether a block to be determined is the motion region or the rest region.

Note that, also in the determination using the principle component analysis, it may be determined whether the block C of (m×n) pixels at the same position with regard to the (N−1) difference images is the motion region or the rest region, based on the (N−1) difference images created from the N monochrome images taken successively. This process is the same as the above process except the number of dimensions, and hence detailed description is omitted.

As described above, the object detection device 1 of the present embodiment includes the image obtainer 3, the difference image creator 4a, and the determiner 4b. The image obtainer 3 is configured to obtain images of the predetermined image sensed area sequentially. The difference image creator 4a is configured to calculate the difference image B1 of two images A1 and A2 obtained sequentially by the image obtainer 3. The determiner 4b is configured to determine whether each of a plurality of blocks C obtained by dividing the difference image B1 in the horizontal direction and the vertical direction is the motion region in which a detection target in motion is present or the rest region in which an object at rest is present. The determiner 4b is configured to determine whether a block C is the motion region or the rest region, based on pixel values of a plurality of pixels constituting this block C, with regard to each of the plurality of blocks C.

As described above, the determiner 4b determines whether a block C is the motion region or the rest region based on the pixel values of the pixels constituting this block C with regard to each of the blocks C generated by dividing the difference image.

In a case of extracting a moving object (e.g., a person) from the difference image obtained by an interframe difference or a background difference, when a person as the detection target wears clothes with a similar color to the background, a human body may be detected as divided parts, and it is necessary to perform a process of connecting divided regions. In contrast, in the present embodiment, it is determined whether each block is the motion region or the rest region, and therefore there is no need to perform the process of connecting the divided regions, and thus load on image processing can be reduced.

Further, in a case of determining whether each block is the motion region or the rest region based on a representative value (e.g., an average value) of pixel values of pixels constituting each block, some of the pixel values may be varied due to unwanted effects such as noise, and thereby the representative value may change. Consequently, the incorrect determination result may be obtained. In contrast, in the present embodiment, the determiner 4b determines whether each block is the motion region or the rest region based on pixel values of a plurality of pixels of each block. Therefore, even when some of the pixel values change due to unwanted effects such as noise, determination is performed based on most of the pixel values which do not suffer from the unwanted effects such as noise, and consequently, occurrence of incorrect determination can be reduced.

Further, even if some blocks are the same in the representative value of the pixel values of the plurality of pixels, they may be different in the pixel values of the plurality of pixels. In this case, determining based on only the representative value whether such blocks are the motion region or the rest region may cause an incorrect result. In contrast, in the present embodiment, the determiner 4b determines whether a block is the motion region or the rest region based on the pixel values of the plurality of pixels constituting this block, and therefore occurrence of incorrect determination can be reduced.

Further, in the present embodiment, the difference image creator 4a creates the (N−1) difference images from N images obtained successively from the image obtainer 3. The determiner 4b divides each of the (N−1) difference images in the horizontal direction and the vertical direction to generate a plurality of blocks with m pixels in the horizontal direction and n pixels in the vertical direction. As for a block at the same position with regard to the (N−1) difference images, the determiner 4b treats a set of difference values of [(N−1)×m×n] pixels constituting the blocks as a point in the [(N−1)×m×n] dimension space. The determiner 4b performs the multiple classification analysis based on learning images preliminarily collected to calculate in advance the boundary plane separating the [(N−1)×m×n] dimension space into the space in which a detection target in motion is present and another space in which an object at rest is present. Further, the determiner 4b determines whether the point indicative of the pixel values of the [(N−1)×m×n] pixels constituting the blocks exists on the motion region side or the rest region side with regard to the above boundary plane, to determine whether this block is the motion region or the rest region.

Note that, in the above explanation, the determiner 4b performs the multiple classification analysis to determine whether each block is the motion region or the rest region. However, there is no intent to limit the determination method by the determiner 4b to the above method. It may be determined whether the block is the motion region or the rest region in the following manner.

For example, with regard to each of the plurality of blocks, when the number of pixels, whose difference values exceed a predetermined threshold, of the plurality of pixels constituting a block is equal to or more than a predetermined determination criterion, the determiner 4b determines that this block is the motion region. When the number of pixels whose difference values exceed the predetermined threshold is less than the predetermined determination criterion, the determiner 4b determines that this block is the rest region.

With regard to the motion region in which the detection target in motion is present, it is considered that changes in pixel values between the two monochrome images A1 and A2 taken successively tend to increase and therefore the difference values of the pixels constituting the block also may increase. Hence, by comparing the number of pixels whose difference values exceed the threshold with the predetermined determination criterion, it is possible to determine whether the block is the motion region or the rest region. Therefore, whether the block is the motion region or the rest region can be determined by a simplified process.

Further, in a case of creating two or more difference images from three or more monochrome images taken successively and determining based on the two or more difference images whether each block is the motion region or the rest region, whether the block is the motion region or the rest region can be performed in the following manner.

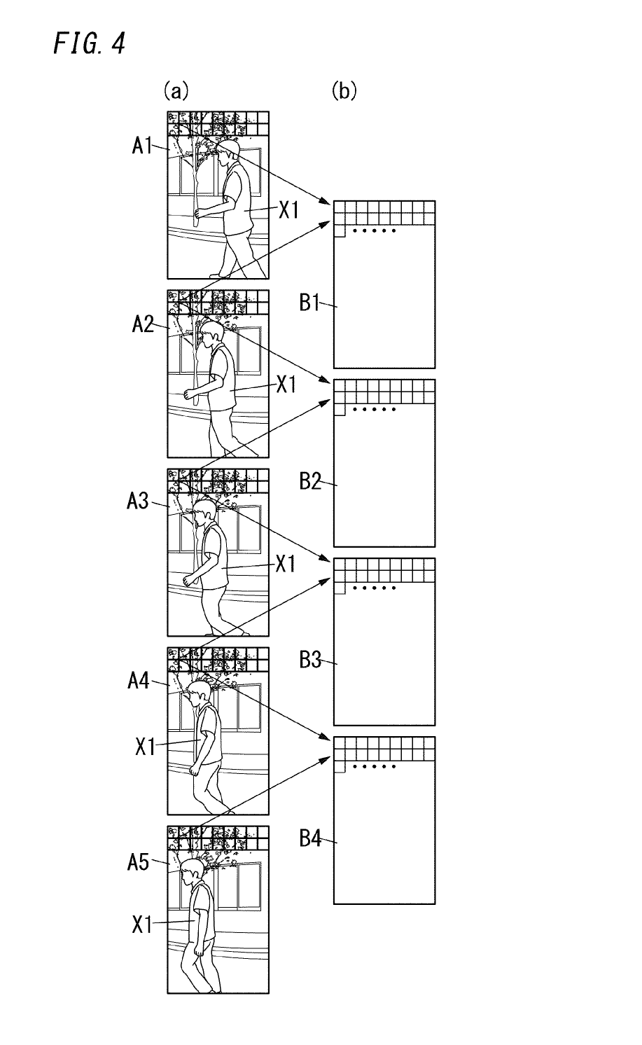

FIG. 4 is an explanatory diagram relating to a case of creating four difference images B1 to B4 from five monochrome images A1 to A5 taken successively and determining based on these four difference images whether each block is the motion region or the rest region. FIG. 4 (a) is an explanatory diagram showing the monochrome images imported from the camera, and FIG. 4 (b) is an explanatory diagram showing the difference images created from the monochrome images. Note that, in the example shown in FIG. 4 (a), a person X1 in motion is present in the five monochrome images A1 to A5.

The image obtainer 3 imports, from the camera 2, the monochrome image A1 at time (t−2), the monochrome image A2 at time (t−1), the monochrome image A3 at time t, the monochrome image A4 at time (t+1), and the monochrome image A5 at time (t+2). When importing image data on the monochrome image from the camera 2, the image obtainer 3 outputs the imported image data to the processor 4. When receiving the image data from the image obtainer 3, the processor 4 stores this image data in the image memory 5.

Each time the image obtainer 3 imports a monochrome image, the difference image creator 4a creates the difference image between the currently imported monochrome image and the previously imported monochrome image, and consequently creates the four difference images B1 to B4 from the five monochrome images A1 to A5 taken successively.

When the difference image is created by the difference image creator 4a, the determiner 4b divides the difference image in the horizontal direction and the vertical direction to create blocks with a predetermined size (e.g., 64 (=8×8) pixels).

Subsequently, the determiner 4b compares difference values of 256 (=64×4) pixels constituting a group of blocks at the same position with regard to the four difference images B1 to B4 with the threshold, and determines, based on the total number of pixels whose difference values exceed the threshold, whether a region represented by the group of blocks is the motion region or the rest region.

When the block is the motion region, it is considered that changes in the pixel values between the consecutive two monochrome images will be large and the number of pixels whose difference values exceed the threshold may be large. In view of this, with regard to the 256 pixels constituting the group of blocks at the same position with regard to the difference image B1 to B4, the determiner 4b determines that the region represented by the group of blocks is the motion region when the number of pixels whose difference values exceed the threshold is equal to or more than the predetermined determination value, and determines that the region represented by the group of blocks is the rest region when the number of pixels whose difference values exceed the threshold is less than the predetermined determination value.

As described above, when the image obtainer 3 imports the N monochrome images taken successively from the camera 2, the difference image creator 4a creates the (N−1) difference images from the N monochrome images taken successively (N is an integer of 2 or more). The determiner 4b divides each of the (N−1) difference images in the horizontal direction and the vertical direction to create a plurality of blocks with m pixels in the horizontal direction and n pixels in the vertical direction (m and n are integers of 2 or more). Thereafter, the determiner 4b compares difference values of [(N−1)×m×n] pixels constituting the group of blocks at the same position with regard to the (N−1) difference images with the predetermined threshold, and determines, based on the number of pixels whose difference values exceed the threshold, whether the region represented by the group of blocks is the motion region or the rest region.

In a case of determining whether the group of blocks at the same position with regard to a plurality of difference images is the motion region or the rest region, determination of whether a block of interest is the motion region or the rest region may be conducted with regard to each difference image, and whether the group of blocks of interest is the motion region or the rest region may be finally determined based on such determination results.

For example, as shown in FIG. 4, in a case where the image obtainer 3 imports the five monochrome images A1 to A5 successively from the camera 2 and the difference image creator 4a creates the four difference images B1 to B4, the determiner 4b divides the difference image in the horizontal direction and the vertical direction to create blocks of a predetermined size each time the difference image is created.

With regard to each of the difference images B1 to B4, the determiner 4b compares the difference values of the pixels constituting the block at the same position with the predetermined threshold. In this regard, the determiner 4b determines that the block is the motion region when the number of pixels whose difference values exceed the threshold is equal to or more than the predetermined determination value, and determines that the block is the rest region when the number of pixels whose difference values exceed the threshold is less than the predetermined determination value.

The following TABLE 1 shows examples of results of determination of whether the blocks at the same position with regard to the difference images B1 to B4 are the motion region or the rest region.

In example 1, with regard to each of the difference images B1 and B2 which are half of all the difference images, the block at the same position is determined as the motion region, and with regard to each of the difference images B3 and B4 which are other half of all the difference images, the block at the same position is determined as the rest region.

In example 2, with regard to each of the three difference images B1 to B3, the block at the same position is determined as the motion region, and with regard to only the difference image B4, the block at the same position is determined as the rest region.

In example 3, with regard to only the difference image B4, the block at the same position is determined as the motion region, and with regard to each of the remaining difference images B1 to B3, the block at the same position is determined as the motion region.

In this regard, a method of finally determining, by the determiner 4b, whether the group of blocks at the same position is the motion region or the rest region based on the determination result relating to the difference images B1 to B4 may be a method based on the rule of the majority or a method based on logical disjunction regarding “motion” as true. TABLE 1 shows the determination results of these two methods.

TABLE 1

| | Example 1 | Example 2 | Example 3 |
|---|---|---|---|
| Determination result relating | Motion | Motion | Rest |
| to the difference image B1 | | | |
| Determination result relating | Motion | Motion | Rest |
| to the difference image B2 | | | |
| Determination result relating | Rest | Motion | Rest |
| to the difference image B3 | | | |
| Determination result relating | Rest | Rest | Motion |
| to the difference image B4 | | | |
| Final determination | Motion | Motion | Rest |
| (Rule of the majority) | | | |
| Final determination | Motion | Motion | Motion |
| (Logical disjunction regarding | | | |
| “motion” as true) | | | |

In a case of determining based on the rule of the majority, in examples 1 and 2, with regard to half or more of the difference images B1 to B4, the block is determined as the motion region, and therefore the determiner 4b finally determines that the region represented by the group of blocks is the motion region. However, in example 3, the block is determined as the motion region with regard to less than half of the difference images B1 to B4, and therefore the determiner 4b finally determines that the region represented by the group of blocks is the rest region. In contrast, in a case of determining based on the logical disjunction regarding “motion” as true, in examples 1 to 3, with regard to at least one of the difference images B1 to B4, the block is determined as the motion region, and therefore the determiner 4b finally determines that the region represented by the group of blocks is the motion region with regard to any of examples.

In other words, the determiner 4b performs a first process and a second process in the process of determining whether the block is the motion region or the rest region. In the first process, the determiner 4b compares the difference values of the (m×n) pixels constituting the block with the predetermined threshold with regard to each of the (N−1) difference images, and determines, based on the number of pixels whose difference values exceed the threshold, whether the block is the motion region or the rest region. In the second process, with regard to the group of blocks at the same position in the (N−1) difference images, the determiner 4b determines, based on the result of the first process, whether the region represented by the group of blocks of the (N−1) difference images is the motion region or the rest region.

As described above, the determiner 4b determines whether each of the blocks of the plurality of difference images is the motion region or the rest region. Thereafter, the determiner 4b determines, based on the determination results with regard to the individual difference images, whether the region represented by the group of blocks at the same position with regard to the difference images is the motion region or the rest region. Therefore, it is possible to more accurately determine whether the region represented by the group of blocks is the motion region or the rest region.

Note that, the determiner 4b determines whether each of blocks C obtained by dividing the difference image is the motion region or the rest region. The size of the block C is preliminarily determined based on the following conditions.

The conditions for determining the size of the block C may include a size of the detection target, a distance from the camera 2 to the detection target, a moving speed of the detection target, and a time interval (frame rate) at which the image obtainer 3 obtains images from the camera 2. Among these conditions, the frame rate is decided in the following manner.

The object detector 4c determines, as the detection target in motion, a region at which two monochrome images taken successively overlap each other partially, and tracks this region. In view of this, the frame rate is decided so that an overlap of the two monochrome images taken successively occurs at a region at which a person exists.

Note that, the size of the detection target which would appear in the image is specified to some extent in a design stage, based on a standard size of the detection target (e.g., a standard body height of an adult), a distance from the camera 2 to the detection target, and an angle of view and a magnification of a lens of the camera 2.

A designer decides the frame rate, based on the size of the detection target to be present in the image and a standard moving speed of the detection target (e.g., a walking speed of a person), so that the overlap of the two monochrome images taken successively occurs at a region at which a person exists, and inputs the set frame rate in the object detection device 1.

Note that, the distance from the camera 2 to the detection target and the size of the detection target to be present in the image are estimated in the following manner.

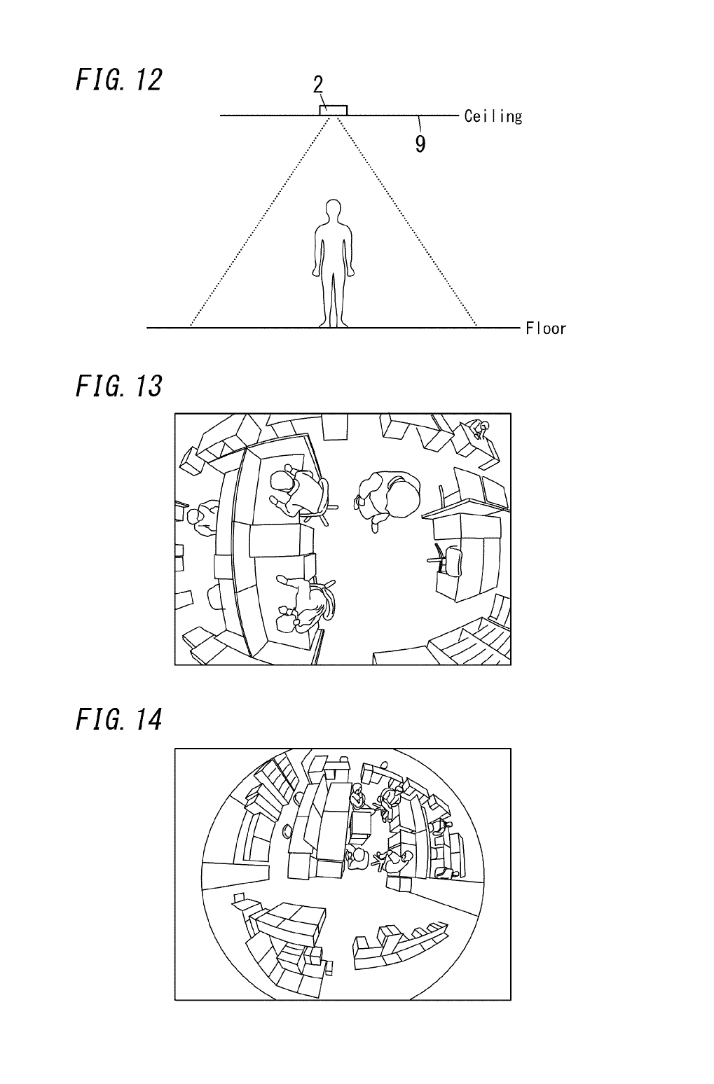

As shown in FIG. 12, in a case where the camera 2 installed on a ceiling 9 takes an image of the image sensed area below the camera 2, when the camera 2 has a narrow-angle lens, the distances from the camera 2 to the detection target at the center of the image and the periphery of the image are almost the same.

FIG. 13 shows an example of the image taken by the camera 2 having the narrow-angle lens. In this regard, the height of the installation site of the camera 2, the standard body height of a person (e.g., an adult) selected as the detection target, and the sitting height of the detection target are known. The designer can decide the distance from the camera 2 to the detection target to some extent based on such information

If the distance from the camera 2 to the detection target is given, the designer can estimate the size of the detection target to be present in the image, based on known data such as the standard size of the person (e.g., an adult) selected as the detection target and the number of pixels, the angle of view, and the magnification of the lens of the camera 2.

In the example of FIG. 12, the camera 2 is installed on the ceiling 9. However, the camera 2 may be installed on a wall. In this case, an image of the detection target is taken by the camera 2 in the horizontal direction.

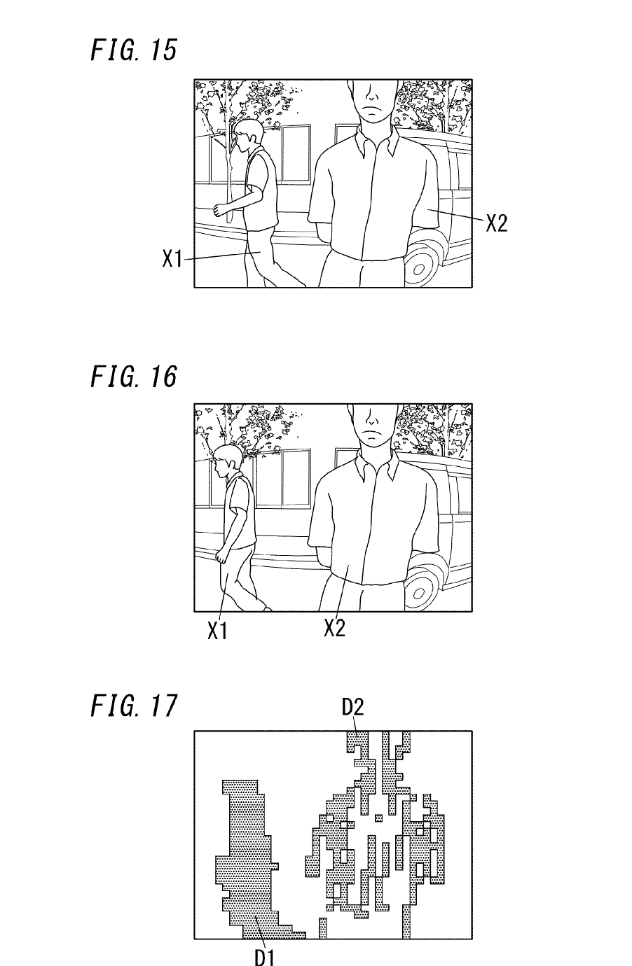

FIG. 15 shows an example of the image taken by the camera 2 installed on the wall. In this case, it is difficult to specify the distances from the camera 2 to the detection targets X1 and X2, and therefore the designer assumes that the position at which the detection target is to be detected is included in a certain area, and uses the distance from the camera 2 to this position as the distance from the camera 2 to the detection target.

When the size of the detection target to be present in the image is estimated in the aforementioned manner, the designer sets a width of the block C in the moving direction of the detection target to be a dimension which is 1/z times or more longer and equal to or shorter than the width of the detection target of the moving direction.

Note that, as shown in FIG. 15, in a case where the camera 2 is installed on the wall and persons as the detection target move left and right in the image, when an image of a person at a predetermined distance from the camera 2 is taken, a dimension corresponding to the width of the figure of the person present in the image is selected as the width of the detection target in the moving direction.

Further, as shown in FIG. 12, in a case where the camera 2 is installed on the ceiling and a person may move in any direction in the image, a length of one side of a rectangular region enclosing the figure of the person present in the image is selected as the width of the detection target in the moving direction.

Further, the variable z denotes the number of difference images used for determination of whether the block is the motion region or the rest region. For example, when the number of difference images used for the determination is four, the width of the block C in the moving direction is set to be equal to or more than ¼ times longer and equal to or less than the width of the detection target in the moving direction.

In this regard, for the following reasons, it is preferable that the size of the block C be set to be equal to or more than ¼ times longer and equal to or less than the width of the detection target in the moving direction.

When the moving speed of the detection target is more than the sampling rate of the image (i.e., the number of overlaps between the detection targets in the successively taken images decreases), the number of blocks in which the figure of the detection target is present decreases with regard to the (z+1) monochrome images obtained by the image obtainer 3 to create the z difference images used in the determination. Consequently, the number of blocks including only the background tends to increase, and the difference value between the images taken successively may decrease, and thus failure of detection may occur.

In contrast, when the moving speed of the detection target is less than the sampling rate of the image (i.e., the number of overlaps between the detection targets in the successively taken images increases), the detection target tends to stay at the same position with regard to the images taken successively. Therefore, the (z+1) monochrome images obtained by the image obtainer 3 to create the z difference images used in the determination may resemble each other, and the difference value may decrease and thus failure of detection may still occur.

Further, when the width of the block C in the moving direction is longer than the upper limit of the above setting range, a ratio of the background in the block C tends to increase and therefore the difference value may decrease and failure of detection may occur.

Further, when the width of the block C in the moving direction is shorter than the lower limit of the above setting range, the individual blocks C becomes images of narrow regions. Hence, with regard to the (z+1) monochrome images obtained by the image obtainer 3 to create the z difference images used in the determination, the individual blocks C will show similar patterns. Therefore, the difference value may decrease and failure of detection may occur.

In view of the above, with regard to the block C to be expected to be determined to be the motion region among the blocks in which the detection target in motion is present, it is preferable to adjust the size of the block C so that timing at which almost all of the pixels used for determination of whether the block is the motion region or the rest region indicate the detection target may occur within one or several (two or three) frames.

Actually, the speed of the detection target is not constant, and the size of the detection target in the image may vary depending on the distance from the camera, the angle of view of the lens, the position of the detection target in the image, and the like as described above. Therefore, it is difficult to decide the unique size of the block C. However, experimental results show that any of blocks in which the detection target is present is determined to be the motion region when the width of the block C in the moving direction of the detection target is set to be equal to or more than 1/z longer and equal to or less than the width of the detection target in the moving direction.

By using such a size as the size of the block, it is possible to prevent failure of detection irrespective of the moving speed of the detection target being fast or slow, and the detection target can be detected successfully.

In this regard, FIG. 16 shows an example of the monochrome image, and FIG. 17 shows a result of determination of whether each block is the motion region or the rest region. FIG. 16 and FIG. 17 show images in a case where the camera 2 is installed on the wall, and a detection target X2 stands closer to the camera 2 than a detection target X1 does. Therefore, in this image, the detection target X2 is greater in size than the detection target X1. The size of the block C is set to be suitable for the detection target X1, and thus the whole of the detection target X1 is detected as a single motion region D2. In contrast, the detection target X2 is greater in size than the detection target X1, and therefore the size of the block is small relative to the size of the detection target X2. Consequently, the motion region D2 corresponding to the detection target X2 is detected as separate parts.

Note that, when the camera 2 has a wide-angle lens, as shown in FIG. 14, the detection target present at the center of the image and the detection target present at the periphery of the image may differ in size. Hence, it is preferable that the block at the center and the block at the periphery be different in size.

Further, in the above explanation, the blocks are generated by dividing the difference image in the horizontal direction and the vertical direction, and thereafter whether each block is the motion region or the rest region is determined. Alternatively, first, each of the monochrome images A1 and A2 may be divided in the horizontal direction and the vertical direction to generate the blocks. Thereafter, with regard to the blocks at the same position, difference values between corresponding images may be calculated, and whether each block is the motion region or the rest region may be determined based on the number of pixels whose difference values exceed the threshold.

As described above, when the determiner 4b determines whether the block is the motion region or the rest region, the object detector 4c treats consecutive blocks among one or more blocks determined to be the motion region as one detection target region, and thus one or more detection target regions are extracted. Subsequently, the object detector 4c extracts each detection target region as a region in which the moving object as the detection target exists (step S4 in FIG. 2).

The region determined by the determiner 4b to be the rest region may be classified into a background region in which the detection target does not exist and a static region in which the detection target exists but stays. Hence, to detect accurately the detection target, it is necessary to extract the static regions from the rest regions to detect the detection target at rest (e.g., a person and a vehicle).

Generally, it is difficult to detect a person or vehicle at rest from the rest region. Therefore, in consideration of temporal change in the motion region in a process in which the detection target stops moving, the object detection device 1 of the present embodiment detects the static region based on such change.

In more detail, the object detection device 1 detects such change that a region is the motion region at a past timing but is not the motion region at a present timing, in order to extract and track the static region (static object). This is described in detail hereinafter.

The object detector 4c treats consecutive blocks among one or more blocks determined to be the motion region as one detection target region.

Each time the image obtainer 3 imports an image from the camera 2, the determiner 4b performs the process of determining whether the block is the motion region or the rest region, and additionally the object detector 4c performs a process of detecting the detection target. In other words, in step S5, based on a relationship between the previously calculated detection target region and the currently calculated detection target region, one is selected from two options. In one of the two options the previous detection target region is used again as a region in which the static object exists and the current detection target region is deleted, and in the other the current detection target region is used as the region in which the static object exists.

In this regard, when any one of the following conditions 1, 2, and 3 is fulfilled, the object detector 4c determines that the detection target present in the previous detection target region becomes at rest. Thereafter, the object detector 4c deletes the currently calculated detection target region, and determines that the previously calculated detection target region is the static region in which the detection target exists to track the static object.

In this regard, the condition 1 is that the currently calculated detection target region is included in the previously calculated detection target region. The condition 2 is that the currently calculated detection target region and the previously calculated detection target region overlap and a ratio of an area of the currently calculated detection target region to an area of the previously calculated detection target region is less than a predetermined threshold. The condition 3 is that there is no overlap between the currently calculated detection target region and the previously calculated detection target region.

In summary, the object detector 4c is configured to determine that the detection target is at rest, and consider the previous detection target region as a region in which an object to be detected (detection target) is present, when any one of a case where the currently calculated detection target region is included in the previously calculated detection target region (condition 1), a case where the current detection target region and the previous detection target region overlap and the ratio of the area of the current detection target region to the area of the previous detection target region is less than the predetermined threshold (condition 2), and a case where there is no overlap between the current detection target region and the previous detection target region (condition 3) occurs.

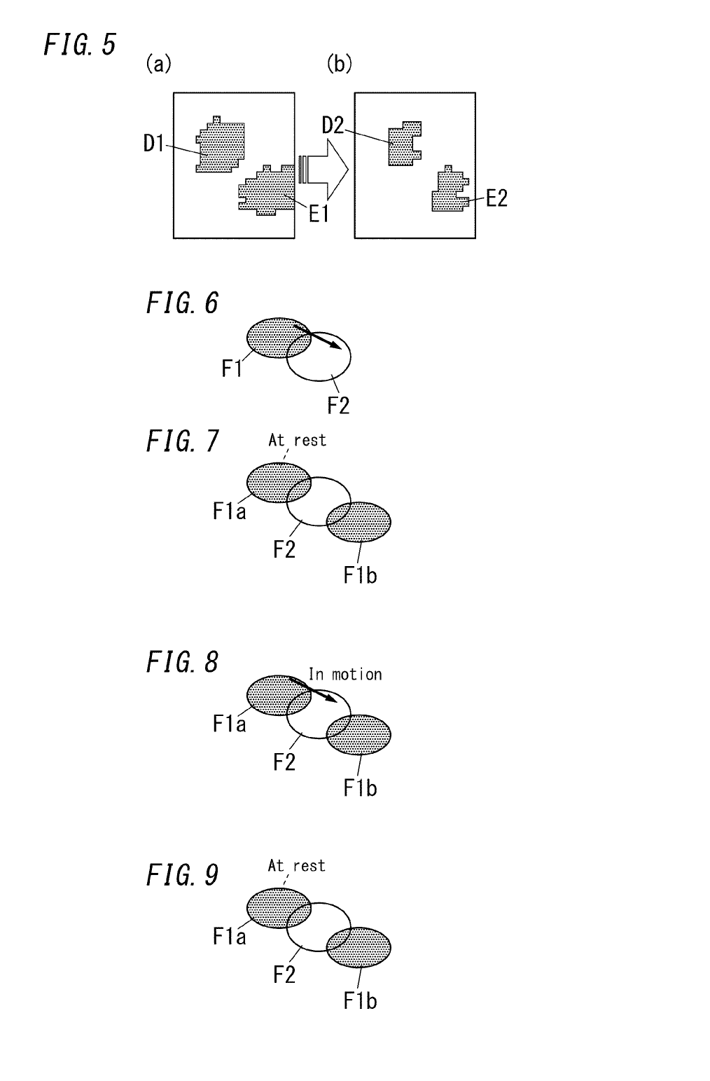

For example, it is assumed that as shown in FIG. 5 (a) and FIG. 5 (b) the detection target region is changed between the previous time and the current time. FIG. 5 (a) shows the previously detected detection target regions D1 and E1, and FIG. 5 (b) shows the currently detected detection target regions D2 and E2.

In this detection example, the current detection target regions D2 and E2 overlap the previous detection target regions D1 and E1 respectively, and the ratios of the areas of the current detection target regions D2 and E2 to the areas of the previous detection target regions D1 and E1 are less than the predetermined threshold.

It is considered that this is because the detection target present in the previous detection target regions D1 and E1 comes to be at rest and the number of moving parts of the detection target decreases. Hence, the object detector 4c determines that the previous detection target regions D1 and E1 to be the static regions in which the detection target exists, and continuously uses these regions but deletes the detection target regions D2 and E2 obtained by current detection.

Next, the processes of steps S6 to S14 for tracking the moving object is described below.

When the previously detected detection target region and the currently-calculated detection target region overlap, the object detector 4c determines that the same detection target exists.

Further, the object detector 4c changes a determination condition for calculating the current position of the detection target from the previous and current detection target regions, based on whether the detection target present in the previously calculated detection target region is determined as being at rest. Further, when determining that the detection target present in the previously calculated detection target region is not at rest, the object detector 4c changes the determination condition for calculating the current position of the detection target from the previous and current detection target regions, according to a parameter representing the movement of the detection target.

How to change this determination condition is described in detail with reference to specific examples hereinafter.

Note that, the parameter representing the movement of the detection target is the speed of the detection target, for example. The object detector 4c calculates a position of a center of gravity of the detection target region in which the detection target exists, and calculates the speed of the detection target from a temporal change in this position of the center of gravity.

First, the object detector 4c determines whether the number of previous detection target regions overlapping the currently calculated detection target region F2 is one or more (step S6 in FIG. 2).

As shown in FIG. 6, when the currently calculated detection target region F2 overlaps only the previously calculated detection target region (the first detection target region) F1 and does not overlap another previously calculated detection target region (the second detection target region) (not shown), the object detector 4c determines that the detection target present in the detection target region F1 has moved to the detection target region F2 and tracks the detection target (step S7 in FIG. 2).

In this case, the object detector 4c determines that the detection target has moved to the currently detected detection target region F2, irrespective of whether the previously detected detection target region F1 is the motion region or the static region.

Further in step S6, when determining that the previously calculated detection target regions (the first and second detection target regions) F1a and F1b overlap the currently calculated detection target region F2 (see FIG. 7 to FIG. 10), the object detector 4c determines whether the first detection target present in the first detection target region F1a is at rest (step S8).

In this regard, when the first detection target present in the first detection target region F1a is at rest (Yes in step S8), the object detector 4c determines that the detection target present in the first detection target region F1a still stays in the first detection target region F1a as shown in FIG. 7 (step S9).

Alternatively, when determining that the first detection target present in the first detection target region F1a is in motion (No in step S8), the object detector 4c determines whether the second detection target present in the second detection target region F1b is at rest (step S10).

In this regard, when the second detection target is in motion (No in step S10), the object detector 4c makes comparison of a speed V1 of the first detection target with a speed V2 of the second detection target (step S11) and identifies the detection target which has moved to the current detection target region F2 based on the result of the comparison.

When the speed V1 of the first detection target is more than the speed V2 of the second detection target, the object detector 4c determines that, as shown in FIG. 8, the first detection target which was present in the first detection target region F1a at previous detection has moved to the current detection target region F2 (step S12).

When the speed (moving speed) V1 of the first detection target is equal to or less than the speed (moving speed) V2 of the second detection target, the object detector 4c determines that, as shown in FIG. 9, the first detection target which was present in the first detection target region F1a at previous detection still stays in the first detection target region F1a (step S13).

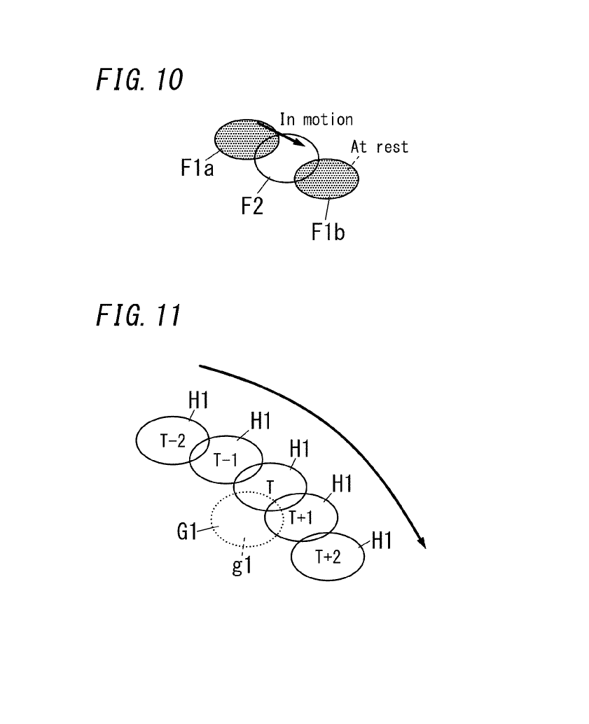

Further, when determining that the second detection target present in the second detection target region F1b is at rest in step S10, the object detector 4c determines that, as shown in FIG. 10, the first detection target which was present in the first detection target region F1a has moved to the current detection target region F2 (step S14).

To summarize the aforementioned determination process, when the previous detection target region (the first detection target region) F1 and the current detection target region F2 overlap and the current detection target region F2 does not overlap another previous detection target region (the second detection target region), the object detector 4c determines that the detection target which was present in detection target region F1 has moved to the current detection target region F1.

Further, when it is determined that the current detection target region F2 overlaps both the previous first and second detection target regions F1a and F1b and that the detection target which was present in the first detection target region F1a is at rest, the object detector 4c determines that the detection target which was present in the first detection target region F1a still stays in the first detection target region F1a.

Further, when it is determined that the current detection target region F2 overlap both the previous detection target region (the first detection target region) F1a and the previous detection target region (the second detection target region) F1b and that both the first detection target present in the first detection target region F1a and the second detection target present in the second detection target region F1b are in motion, the object detector 4c performs the following determination process.

When the speed V1 of the first detection target is more than the speed V2 of the second detection target, the object detector 4c determines that the first detection target has moved to the current detection target region F2. When the speed V1 of the first detection target is equal to or less than the speed V2 of the second detection target, the object detector 4c determines that the first detection target has still stayed in the first detection target region F1a.

Further, when it is determined that the current detection target region F2 overlap both the previous detection target region (the first detection target region) F1a and the previous detection target region (the second detection target region) F1b and that the first detection target present in the first detection target region F1a is in motion and the second detection target present in the second detection target region F1b is at rest, the object detector 4c determines that the first detection target has moved to the current detection target region F2.

As described above, the object detector 4c changes the determination condition for calculating the current position of the detection target from the previous and current detection target regions, according to whether the detection target present in the previously calculated detection target region is at rest, or the parameter (e.g., the speed) representing the movement of the detection target in a case where the detection target is not at rest. Therefore, it is possible to identify in detail the position of the detection target.

Further, as shown in FIG. 11, when the detection target g1 present in the detection target region (the first detection target region) G1 extracted at a certain timing is at rest, and at least part of the detection target region (the second detection target region) H1 extracted after the certain timing overlaps this first detection target region G1 at the time T, the object detector 4c performs the following process.

Note that, in FIG. 11, letters shown inside the second detection target regions H1 indicate time at which the second detection target regions H1 are in illustrated positions. FIG. 11 illustrates positions of the second detection target regions H1 at points of time (T−2), (T−1), T, (T+1), and (T+2), respectively. The second detection target region H1 moves from the upper-left side to the lower-right side with time.

At the time T, part of the second detection target region H1 which has moved to the current position overlaps the first detection target region G1. In this case, the object detector 4c stores, as a template image, an image of the first detection target region G1 at the time (T−1) immediately before overlapping of the second detection target region H1.

In other words, the object detector 4c is configured to, when it is determined that the detection target g1 present in the first detection target region G1 obtained at a certain timing is at rest and at least part of the second detection target region H1 obtained after the certain timing overlaps the first detection target region G1, store, as the template image, the image of the first detection target region G1 obtained immediately before overlapping of the second detection target region H1.

Thereafter, at the timing (time (T+2)) when an overlap between the first detection target region G1 and the second detection target region H1 disappears, the object detector 4c performs a matching process between the image of the first detection target region G1 at this timing and the template image to calculate a correlation value between them.

When this correlation value is larger than a predetermined determination value, the object detector 4c determines that the detection target g1 has remained in the first detection target region G1. When this correlation value is smaller than the determination value, the object detector 4c determines that the detection target g1 has moved outside the first detection target region G1.

By doing so, the object detection device 1 can identify the position of the detection target more accurately.

As described above, when the static object (e.g., a part of a human body which is at rest) and the moving object (e.g., a part of a human body which is in motion) are detected, both the static object and the moving object are considered, and thus it is possible to detect the detection target (e.g., a human body) more accurately.

As described above, the object detection device 1 of the present embodiment includes the following first feature. In the first feature, the object detection device 1 includes the image obtainer 3, the difference image creator 4a, and the determiner 4b. The image obtainer 3 is configured to obtain images of the predetermined image sensed area sequentially. The difference image creator 4a is configured to calculate the difference image (e.g., the difference image B1 between two images A1 and A2) between images obtained sequentially by the image obtainer 3. The determiner 4b is configured to determine whether each of a plurality of blocks C obtained by dividing the difference image B1 in the horizontal direction and the vertical direction is the motion region in which a detection target in motion is present or the rest region in which an object at rest is present. The determiner 4b is configured to determine whether a block C is the motion region or the rest region, based on pixel values of a plurality of pixels constituting this block C, with regard to each of the plurality of blocks C.

Further, the object detection device 1 of the present embodiment includes any one of the following second to fifth features in addition to the first feature. Note that, the second to fifth features are optional.

In the second feature, the difference image creator 4a is configured to create the (N−1) difference images from the N images obtained sequentially by the image obtainer 3. The determiner 4b is configured to divide each of the (N−1) difference images in the horizontal direction and the vertical direction to generate a plurality of blocks with m pixels in the horizontal direction and n pixels in the vertical direction. The determiner 4b is configured to, as for a group of blocks at the same position with regard to the (N−1) difference images, treat a set of difference values of [(N−1)×m×n] pixels constituting the group of blocks as a point in the [(N−1)×m×n] dimension space. The determiner 4b is configured to perform a multiple classification analysis based on preliminarily collected learning images to calculate in advance the boundary plane separating the [(N−1)×m×n] dimension space into the space in which the detection target in motion exists and the space in which the object at rest exists. The determiner 4b is configured to determine whether the point indicated by the set of difference values of the [(N−1)×m×n] pixels constituting the group of blocks is in either side in the [(N−1)×m×n] dimension space to determine whether the group of block is the motion region or the rest region.

In the third feature, the determiner 4b is configured to compare, with regard to each of the plurality of blocks, difference values of pixels constituting a block with a predetermined threshold, and determine whether this block is the motion region or the rest region, based on the number of pixels corresponding to difference values exceed the predetermined threshold.

In the fourth feature, the difference image creator 4a is configured to create the (N−1) difference images from the N monochrome images sequentially obtained by the image obtainer 3 (N is an integer of 2 or more). The determiner 4b is configured to divide each of the (N−1) difference images in the horizontal direction and the vertical direction to create a plurality of blocks with m pixels in the horizontal direction and n pixels in the vertical direction (m and n are integers of 2 or more). The determiner 4b is configured to compare each of the difference values of the [(N−1)×m×n] pixels constituting the group of blocks at the same position with regard to the (N−1) difference images with the predetermined threshold, and determine whether the region represented by the group of blocks is the motion region or the rest region, based on the total number of pixels whose difference values exceed the threshold.

In the fifth feature, the difference image creator 4a is configured to create the (N−1) difference images from the N monochrome images sequentially obtained by the image obtainer 3. The determiner 4b is configured to divide each of the (N−1) difference images in the horizontal direction and the vertical direction to create a plurality of blocks with m pixels in the horizontal direction and n pixels in the vertical direction. The determiner 4b is configured to compare each of the difference values of the [m×n] pixels constituting each block of interest with regard to each of the (N−1) difference images with the predetermined threshold, and determine whether each block of interest is the motion region or the rest region, based on the total number of pixels whose difference values exceed the threshold. The determiner 4b is configured to finally determine, based on results of determination of whether each block of interest of each of the difference images is the motion region or the rest region as for the group of blocks of interest at the same position with regard to the (N−1) difference images, whether the region represented by the group of blocks of interest with regard to the (N−1) difference images is the motion region or the rest region.

Further, the object detection device 1 of the present embodiment includes the following sixth feature. In the sixth feature, the object detection device 1 further includes the object detector 4c configured to detect the detection target from the region determined as the motion region. The object detector 4c is configured to determine, as the detection target region, each of consecutive blocks of one or more blocks determined as the motion region. The object detector 4c is configured to, when the currently obtained detection target region is included in the previously obtained detection target region, or when the currently obtained detection target region and the previously obtained detection target region overlap each other and a ratio of an area of the currently obtained detection target region to an area of the previously obtained detection target region is smaller than a predetermined threshold, or when there is no overlap between the currently obtained detection target region and the previously obtained detection target region, determine that the detection target is at rest and then regard the previously obtained detection target region as a region in which the detection target is present. Note that, the sixth feature is optional.

Further, the object detection device 1 of the present embodiment includes the following seventh feature in addition to the sixth feature. In the seventh feature, the object detector 4c is configured to, when the currently obtained detection target region and the previously obtained detection target region overlap each other, determine that the same detection target is present in the currently obtained detection target region and the previously obtained detection target region. The object detector 4c is configured to change a determination condition for determining a current location of the detection target from the currently obtained detection target region and the previously obtained detection target region, in accordance with whether the detection target present in the previously obtained detection target region is at rest, or a parameter indicative of a movement of the detection target when it is determined that the detection target is not at rest. Note that, the seventh feature is optional.

Further, the object detection device 1 of the present embodiment includes the following eighth feature in addition to the seventh feature. In the eighth feature, the parameter is the speed of movement of the detection target. The object detector 4c is configured to calculate the speed of movement of the detection target based on a temporal change in the position of the center of gravity of the detection target region. Note that, the eighth feature is optional.

Further, the object detection device 1 of the present embodiment includes the following ninth to thirteenth features in addition to the sixth feature. Note that, the ninth to thirteenth features are optional.

In the ninth feature, the object detector 4c is configured to, when the previous first detection target region F1 and the current detection target region F2 overlap each other but there is no overlap between the current detection target region F2 and the previous second detection target region, determine that the detection target present in the first detection target region F1 has moved to the current detection target region F2.

In the tenth feature, the object detector 4c is configured to, when the current detection target region F2 overlaps the previous first detection target region F1a and the previous second detection target region F1b and it is determined that the detection target present in the first detection target region F1a is at rest, determine that the detection target present in the first detection target region F1a stays in the first detection target region F1a.

In the eleventh feature, the object detector 4c is configured to, when the current detection target region F2 overlaps the previous first detection target region F1a and the previous second detection target region F1b and it is determined that both the first detection target present in the first detection target region F1a and the second detection target present in the second detection target region F1b are in motion and when the speed of the first detection target is more than the speed of the second detection target, determine that the first detection target has moved to the current detection target region F2. The object detector 4c is configured to, when the current detection target region F2 overlaps the previous first detection target region F1a and the previous second detection target region F1b and it is determined that both the first detection target present in the first detection target region F1a and the second detection target present in the second detection target region F1b are in motion and when the speed of the first detection target is equal to or less than the speed of the second detection target, determine that the first detection target has remained in the first detection target region F1a.

In the twelfth feature, the object detector 4c is configured to, when the current detection target region F2 overlaps the previous first detection target region F1a and the previous second detection target region F1b and it is determined that the first detection target present in the first detection target region F1a is in motion and the second detection target present in the second detection target region F1b is at rest, determine that the first detection target has moved to the current detection target region F2.

In the thirteenth feature, the object detector 4c is configured to, when it is determined that the detection target g1 present in a first detection target region G1 obtained at the certain timing is at rest and at least part of the second detection target region H1 obtained after the certain timing overlaps the first detection target region G1, store, as a template image, an image of the first detection target region G1 obtained immediately before overlapping of the second detection target region H1. The object detector 4c is configured to, at a timing when an overlap between the first detection target region G1 and the second detection target region H1 disappears, perform a matching process between an image of the first detection target region G1 at this timing and the template image to calculate a correlation value between them. The object detector 4c is configured to, when the correlation value is larger than a predetermined determination value, determine that the detection target has remained in the first detection target region G1. The object detector 4c is configured to, when the correlation value is smaller than the determination value, determine that the detection target has moved outside the first detection target region G1.

According to the aforementioned object detection device 1 of the present embodiment, with regard to each of a plurality of blocks generated by dividing the difference image, the determiner 4b determines whether a block is the motion region or the rest region, based on the pixel values of a plurality of pixels constituting this block.

In a case of extracting a moving object (e.g., a person) from the difference image obtained by an interframe difference or a background difference, when a person as the detection target wears clothes with a similar color to the background, a human body may be detected as divided parts, and it is necessary to perform a process of connecting divided regions. In contrast, in the present embodiment, it is determined whether each block is the motion region or the rest region, and therefore there is no need to perform the process of connecting the divided regions, and thus load on image processing can be reduced.

Further, in a case of determining whether each block is the motion region or the rest region based on a representative value (e.g., an average value) of pixel values of pixels constituting each block, some of the pixel values may be varied due to unwanted effects such as noise, and thereby the representative value may change. Consequently, the incorrect determination may be performed. In contrast, in the present embodiment, the determiner 4b determines whether each block is the motion region or the rest region based on pixel values of a plurality of pixels of each block. Therefore, even when some of the pixel values change due to unwanted effects such as noise, determination is performed based on most of the pixel values which do not suffer from the unwanted effects such as noise, and consequently, occurrence of incorrect determination can be reduced.

Further, even if some blocks are the same in the representative value of the pixel values of the plurality of pixels, they may be different in the pixel values of the plurality of pixels. In this case, determining based on only the representative value whether such blocks are the motion region or the rest region may cause an incorrect result. In contrast, in the present embodiment, the determiner 4b determines whether a block is the motion region or the rest region based on the pixel values of the plurality of pixels constituting this block, and therefore occurrence of incorrect determination can be reduced.

### Embodiment 2

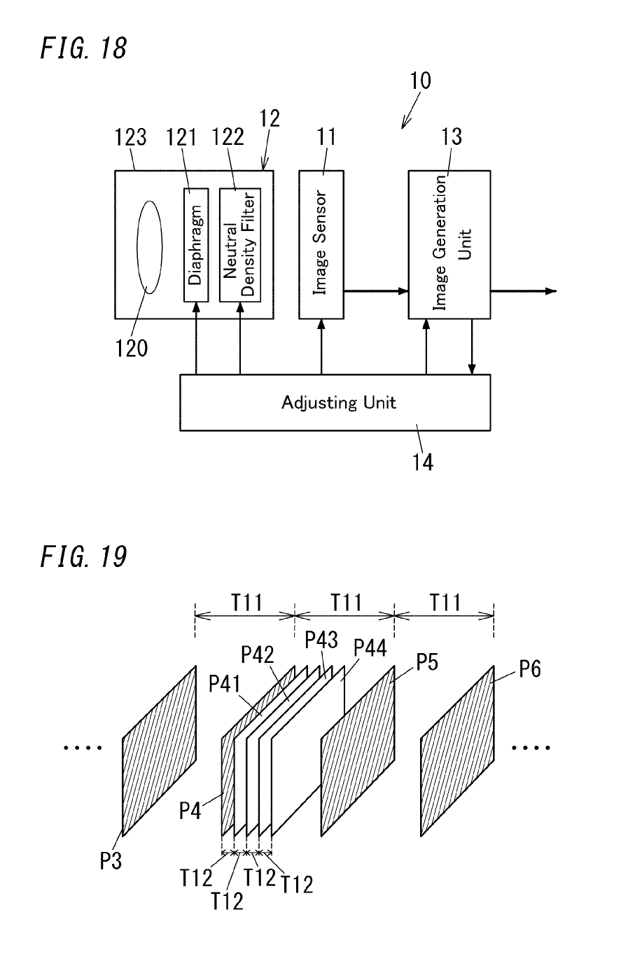

An object detection device 1 of the present embodiment includes an image sensing device 10 shown in FIG. 18 as a camera 2. Further, the object detection device 1 of the present embodiment includes an image obtainer 3, a processor 4, an image memory 5, and an outputter 6 in a similar manner to the embodiment 1. In summary, the present embodiment mainly relates to the image sensing device 10. Note that, explanations relating to the image obtainer 3, the processor 4, the image memory 5, and the outputter 6 are omitted.

Generally, with regard to image sensing devices for taking images (dynamic images or still images) for recording videos or various image processing, in order to make an exposure amount of an image (brightness) be in an appropriate range, the exposure amount is adjusted (e.g., see document 3 [JP 2009-182461 A]).

When brightness of a photographic object changes drastically and rapidly, in some cases adjustment of the exposure amount of the image sensing device could not follow such change, and in some cases a part or whole of the image may become white or black. Especially, with regard to the image sensing device for taking images at a frame rate in accordance with intended use such as time lapse recording and image processing, the number of frames necessary for adjustment of the exposure amount to compensate such a rapid change may increase and therefore an unsuitable situation for the intended use may occur.

In contrast, with regard to an image sensing device with a high frame rate, even when the number of frames necessary for adjustment of the exposure amount is the same as above, a time period in which images would be taken under an inappropriate exposure state is shortened greatly. However, an electric charge accumulating period of the image sensor decreases with an increase in the frame rate, and therefore shortage of the exposure amount may occur under low illumination. Further, a period for reading out accumulated electric charges of the image sensor may decrease, and thus an operation frequency of a circuit for reading out electric charges may increase, and consequently this may cause increases in an energy consumption and an amount of heat generation.

In view of the above insufficiency, the present embodiment has aimed to improve responsiveness of adjustment of an exposure amount while suppressing increases in an energy consumption and an amount of heat generation.

Hereinafter, the image sensing device 10 according to the present embodiment is described in detail with reference to drawings. As shown in FIG. 18, the imaging device 10 of the present embodiment includes an image sensor 11, an optical block 12 serving as light controller, an image generation unit 13, an adjusting unit 14, and the like.

The image sensor 11 includes a plurality of pixels each for storing electric charges, and converts an amount of electric charges stored in each pixel into a pixel value and outputs the pixel value. For example, the image sensor 11 is constituted by a solid state image sensor such as a CCD image sensor and a CMOS image sensor. Note that, this image sensor 11 has a function of changing an electric charge accumulating period, so called, an electronic shutter.

The optical block 12 includes optical members including a lens 120, a diaphragm 121, and a neutral density filter 122 and a casing 123 housing the optical members. Light converged by the lens 120 passes through an aperture of the diaphragm 121 and is dimmed (attenuated) by the neutral density filter 122 and enters the image sensor 11. The diaphragm 121 is constituted by a plurality of diaphragm blades and controls an amount of light passing therethrough by increasing and decreasing a diameter of the aperture by changing overlaps between the diaphragm blades. The neutral density filter 122 is constituted by a transmissive liquid crystal panel, and controls an amount of light (an amount of light to be subjected to photoelectric conversion by the image sensor 11) passing therethrough by changing transmissivity of the liquid crystal panel.

The image generation unit 13 reads out pixel values at a predetermined frame rate from the image sensor 11, and performs signal processing (such as amplification) on the read out pixel values to generate images P1, P2, . . . , at the frame rate (=1/T11) (see FIG. 19). In this regard, the image sensor 11 converts an amount of electric charges stored in each pixel into a pixel value and outputs the pixel value, in accordance with instructions from the image generation unit 13.

The adjusting unit 14 evaluates evaluate some or all of pixel values of one image Pn (n=1, 2, . . . ) by a numerical value and adjusts the pixel values so that the evaluation value falls within a predetermined appropriate range, by controlling the diaphragm 121 or the neutral density filter 122 of the optical block 12, the electric charge accumulating period of the image sensor 11, an amplification degree of the image generation unit 13, and/or the like. Note that, the evaluation value is defined as a numerical value. For example, the evaluation value may be an average of pixel values of all of pixels of the image sensor 11 or the highest (greatest) pixel value of pixel values of all of pixels of the image sensor 11. Further, the appropriate range of the evaluation value is set to a range according to a type of the evaluation value (the average or the maximum pixel value).

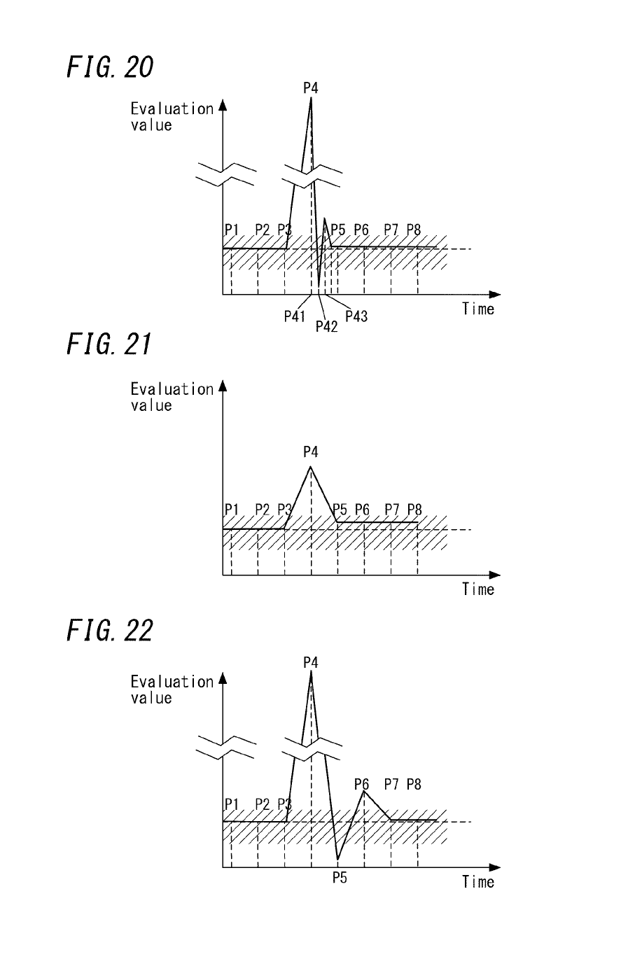

The operation of the adjusting unit 14 is described in more detail. Note that, in FIG. 20 to FIG. 22, a horizontal axis denotes time, and a vertical axis denotes an evaluation value, and an area with hatching indicates an appropriate range of the evaluation value.

For example, as shown in FIG. 21, when the evaluation value of an image P4 becomes two times larger than the evaluation value of an image P3 corresponding to the previous frame, and exceeds the upper limit of the appropriate range, the adjusting unit 14 controls at least one of the diaphragm 121 and the neutral density filter 122 or the electric charge accumulating period of the image sensor 11 to decrease an amount of light entering the image sensor 11 to be half thereof. As a result, it is possible to make the evaluation value of an image P5 corresponding to the next frame be in the appropriate range.

However, as shown in FIG. 22, when the evaluation value of the image P4 reaches the upper limit of the pixel value and is saturated, the adjusting unit 14 controls the diaphragm 121 and the neutral density filter 122 to reduce the amount of light entering the image sensor 11 and shortens the electric charge accumulating period of the image sensor 11 so as to reduce the pixel value, for example. As a result, the evaluation value of the image P5 corresponding to the next frame may fall below the lower limit of the appropriate range.

When the evaluation value of the image P5 falls below the lower limit of the appropriate range, the adjusting unit 14 controls the diaphragm 121 and the neutral density filter 122 to increase the amount of light entering the image sensor 11 and prolongs the electric charge accumulating period of the image sensor 11 so as to increase the pixel value. As a result, an evaluation value of an image P6 corresponding to the next frame may slightly exceed the upper limit of the appropriate range.

When the evaluation value of the image P6 slightly exceeds the upper limit of the appropriate range, the adjusting unit 14 controls at least one of the diaphragm 121 and the neutral density filter 122 to reduce the amount of light entering the image sensor 11. As a result, it is possible to make an evaluation value of an image P7 corresponding to the next frame be in the appropriate range. Note that, in addition to or as an alternative to the diaphragm 121, the neutral density filter 122, and/or the electric charge accumulating period of the image sensor 11, the amplification of the pixel value in the image generation unit 13 can be adjusted in order to increase and decrease the pixel value.

When the evaluation value changes greatly and rapidly as described above, an adjustment period (e.g., a time period with the length of T11×3 in the example of FIG. 22) with the length of several frames is necessary in order to make the evaluation value be in the appropriate range. Hence, the images P5 and P6 generated by the image generation unit 13 in this adjustment period are likely to be inappropriate images which provide excessively bright screen or conversely excessively dark screen.

In view of this, when the evaluation value of the image P4 is deviated from the appropriate range by a predetermined level or more, the adjusting unit 14 controls the image generation unit 13 to be in an adjusting mode of generating images P41, P42, . . . at an adjustment frame rate (=1/T12, T12<<T11) higher than the frame rate (normal frame rate) (=1/T11) (see FIG. 19).

Note that, the predetermined level is set to be 4 times larger than the upper limit of the appropriate range and one fourth as large as the lower limit of the appropriate range, for example. However, a value of the predetermined level is not limited thereto. For example, when the pixel value is represented by a digital value of 8 bits (256 steps), the predetermined level may be set so that the pixel value is 128 or more or 8 or less.

Therefore, even when the evaluation value of the image P4 reaches the upper limit of the pixel value and is saturated and thus the adjustment period with the length of 3 frames is necessary for the adjusting unit 14 to make the evaluation value be in the appropriate range, the adjustment period becomes T12×3 (<<T11×3), and is greatly shortened (see FIG. 20).

When the evaluation value of the image P43 generated in the adjusting mode falls within the appropriate range, the adjusting unit 14 returns the image generation unit 13 from the adjusting mode to the normal mode (a mode in which the frame rate is 1/T11). Therefore, in contrast to a case where the high frame rate is used in the normal mode as described regarding the background art, a period of the adjusting mode (adjustment period) causing an increase in the energy consumption becomes extremely short, and thus it is possible to improve the responsiveness of the adjustment of the exposure amount while suppressing increases in the energy consumption and the amount of heat generation.

As described above, the adjusting unit 14 operates the image generation unit 13 in either the normal mode in which the frame rate is set to the normal frame rate (=1/T11) or the adjusting mode in which the frame rate is set to the adjustment frame rate (=1/T12) higher than the normal frame rate. Further, when the evaluation value of the image generated at the frame rate is deviated from the appropriate range by the predetermined level or more, the adjusting unit 14 sets the image generation unit 13 to the adjusting mode of generating the image at the adjustment frame rate higher than the frame rate (the normal frame rate), and returns the image generation unit 13 to the normal mode of generating the image at the frame rate (the normal frame rate) after generating the image at the adjustment frame rate. When the evaluation value of the image generated in the adjusting mode falls within the appropriate range, the adjusting unit 14 returns the image generation unit 13 from the adjusting mode to the normal mode.

When the frame rate of the image generation unit 13 increases temporarily, there is a possibility of occurrence of mismatching with a receiving side device such as a display device for displaying the image taken by the image sensing device and an image processing device for image processing on the taken image. Therefore, if such a receiving side device can accept a lack of frames (dropping frames), it is preferable that the image generation unit 13 do not output the image generated in the adjusting mode.

In contrast, if such a receiving side device does not accept a lack of frames, it is necessary that in the adjusting mode the image generation unit 13 outputs the image at the same frame rate as the normal mode. Therefore, it is desirable that the adjusting unit 14 return the image generation unit 13 from the adjusting mode to the normal mode when the number of images generated in the adjusting mode reaches the predetermined number of frames (the number of frames capable of being generated within the same time period as the frame period T11 of the normal mode).

For example, it is assumed that the frame rate of the normal mode is 30 fps (frames per seconds) and the adjustment frame rate of the adjusting mode is 120 fps. By returning the image generation unit 13 to the normal mode after the images of 3 frames are generated in the adjusting mode, the image can be generated at the frame rate of 30 fps.

Alternatively, instead of counting the number of frames of the images generated in the adjusting mode, when elapsed time from the time of setting to the adjusting mode reaches predetermined time (time equal to the frame period T11 of the normal mode), the adjusting unit 14 may return the image generation unit 13 from the adjusting mode to the normal mode. In summary, the adjusting unit 14 may return the image generation unit 13 from the adjusting mode to the normal mode when the elapsed time from the setting to the adjusting mode reaches the predetermined time.

In this regard, in the adjusting mode, time necessary for the image generation unit 13 to read out the pixel value from the image sensor 11 is shorter than that in the normal mode. Hence, when the image generation unit 13 does not output the image to an external device in the adjusting mode, it is preferable that the adjusting unit 14 control the image generation unit 13 to read out only pixel values of some of pixels of the image sensor 11 in the adjusting mode.

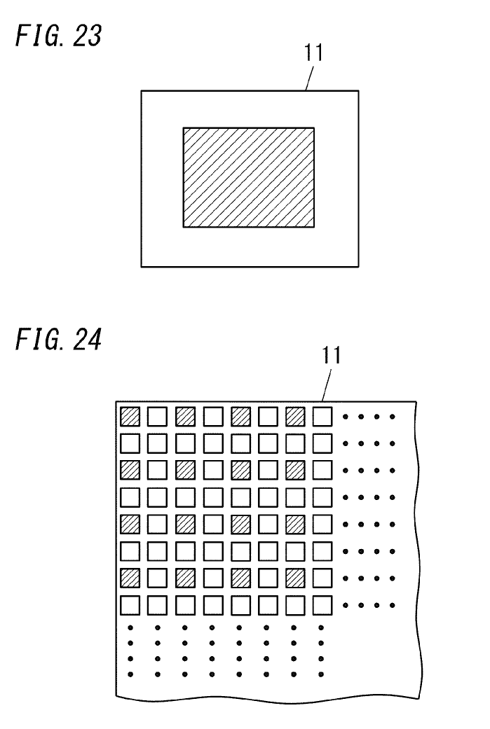

For example, as shown in FIG. 23, the adjusting unit 14 may make the image generation unit 13 read out only pixel values of pixels inside a rectangular area at the center other than the periphery of the pixels of the image sensor 11. Alternatively, as shown in FIG. 24, the adjusting unit 14 may control the image generation unit 13 to read out the pixel values of the pixels arranged in the horizontal direction and the vertical direction intermittently. As described above, in the adjusting mode, by making the adjusting unit 14 control the image generation unit 13 to read out pixel values of some of pixels of the image sensor 11, it is possible to easily increase the frame rate from the frame rate of the normal mode up to the adjustment frame mode without causing an increase in the operation frequency of the image generation unit 13

When the image generation unit 13 is switched from the normal mode to the adjusting mode, the maximum value of the electric charge accumulating period of the image sensor 11 becomes smaller (shorter). In some cases, the electric charge accumulating period set in the normal mode before switching is not available in the adjusting mode after switching.

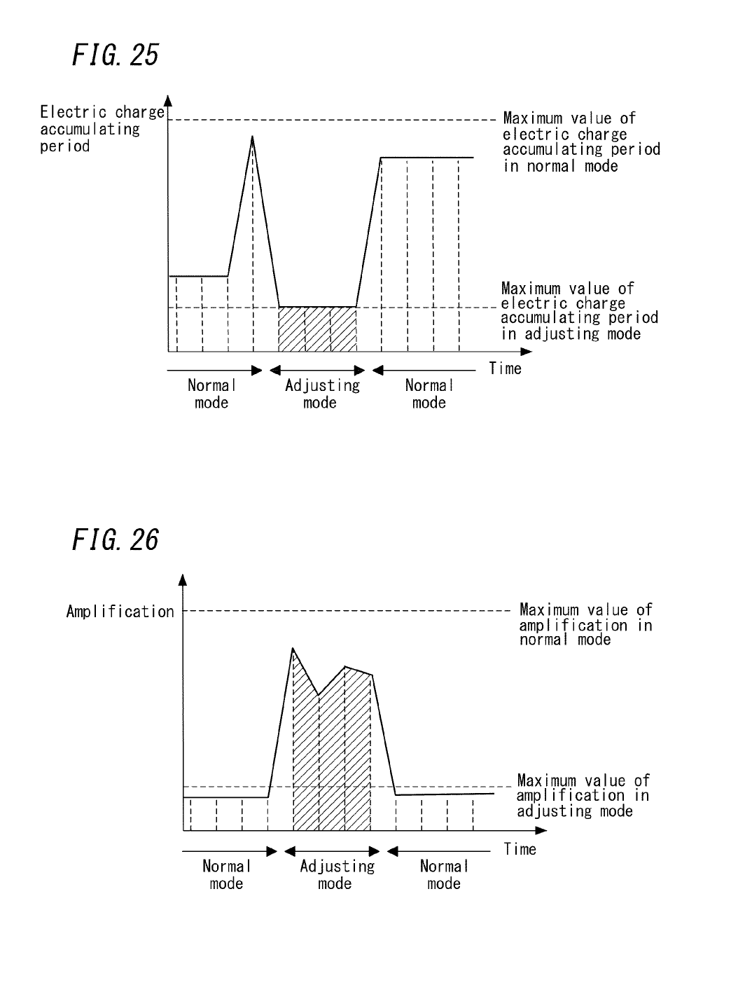

For example, in the adjusting mode after switching, the electric charge accumulating period set in the normal mode is decreased down to an integer (quotient) obtained by dividing the electric charge accumulating period set in the normal mode by the maximum value of the electric charge accumulating period of the adjusting mode (see FIG. 25).

Therefore, in order to keep the evaluation value at low illumination in the adjusting mode to the same extent as that of the normal mode, it is necessary to adjust parameters other than the electric charge accumulating period to compensate a decrease in the pixel value caused by a decrease in the electric charge accumulating period. In this regard, responsiveness in a case of adjusting the amplification of the image generation unit 13 is superior to responsiveness in a case of adjusting the diaphragm 121 and responsiveness in a case of adjusting the neutral density filter 122, and therefore it is preferable to compensate the decrease in the pixel value by adjusting the amplification of the image generation unit 13.

Therefore, when the electric charge accumulating period adjusted in the normal mode exceeds the upper limit of the electric charge accumulating period in the adjusting mode, it is preferable that the adjusting unit 14 sets the electric charge accumulating period in the adjusting mode to the upper limit thereof and control the optical block 12 or the image generation unit 13 to change parameters other than the electric charge accumulating period so as to adjust the pixel value. For example, the amplification may be increased to a ratio equal to an inverse number of a value obtained by dividing the electric charge accumulating period set in the normal mode by the maximum value of the electric charge accumulating period in the adjusting mode, at the time of switching to the adjusting mode.

Further, in a case of compensating a decrease in the maximum value of the electric charge accumulating period in the adjusting mode by adjusting the amplification of the image generation unit 13, it is preferable to set the upper limit of the amplification to a value higher than the upper limit of the amplification in the normal mode. For example, when it is assumed that the maximum value of the electric charge accumulating period in the normal mode is four times larger than the maximum value of the electric charge accumulating period in the adjusting mode, the upper limit of the amplification in the adjusting mode may be set to be four times larger than the amplification in the normal mode (see FIG. 26). By doing so, it is possible to keep the evaluation value at the low illumination in the adjusting mode to the same extent as that in the normal mode.

Note that, when the image generation unit 13 is returned from the adjusting mode to the normal mode, the electric charge accumulating period and the amplification respectively set according to the upper limit of the electric charge accumulating period and the upper limit of the amplification in the adjusting mode may not be suitable for the normal mode. In view of this, it is desirable that, when the image generation unit 13 is returned to the normal mode, the adjusting unit 14 decide the appropriate electric charge accumulating period and the appropriate amplification according to the upper limit of the electric charge accumulating period and the upper limit of the amplification in the normal mode, and adjust other parameters (the diaphragm 120 and the neutral density shutter 121) in accordance with the decided electric charge accumulating period and the decided amplification. For example, the adjusting unit 14 is configured to, when the image generation unit 13 is returned to the normal mode, control the optical block 12 to readjust the electric charge accumulating period. When the readjusted electric charge accumulating period is different from the last electric charge accumulating period in the adjusting mode, the adjusting unit 14 controls the optical block 12 or the image generation unit 13 to change parameters other than the electric charge accumulating period to adjust the pixel value.

As described above, the image sensing device 10 in the present embodiment includes the image sensor 11, the light controller (the optical block 12), the image generator (the image generation unit 13), and the adjuster (the adjusting unit 14). The image sensor 11 includes a plurality of pixels each for storing electric charges and is configured to convert an amount of electric charges stored in each pixel into a pixel value and output the pixel value. The light controller (the optical block 12) is configured to control an amount of light to be subjected to photoelectric conversion by the image sensor 11. The image generator (the image generation unit 13) is configured to read out pixel values at a predetermined frame rate from the image sensor 11 and generate an image corresponding to one frame at the frame rate from the read out pixel values. The adjuster (the adjusting unit 14) is configured to evaluate some or all of the pixel values of the image generated at the frame rate by an evaluation value defined as a numerical value and adjust the pixel values by controlling at least one of the light controller (the optical block 12) and the image generator (the image generation unit 13) so that the evaluation value falls within a predetermined appropriate range. The adjuster (the adjusting unit 14) is configured to, when the evaluation value of the image generated at the frame rate is deviated from the appropriate range by a predetermined level or more, set the image generator (the image generation unit 13) to an adjusting mode of generating an image at an adjustment frame rate higher than the frame rate (the normal frame rate), and after the image generator (the image generation unit 13) generates the image at the adjustment frame rate, set the image generator to a normal mode of generating the image at the frame rate (the normal frame rate).

In summary, the object detection device 1 of the present embodiment includes the following fourteenth feature in addition to the aforementioned first feature. Note that, the object detection device 1 of the present embodiment may include the aforementioned second to thirteenth features selectively.

In the fourteenth feature, the object detection device 1 includes the image sensing device 10 serving as the camera 2 (see FIG. 1). The image sensing device 10 includes the image sensor 11, the light controller (the optical block 12), the image generator (the image generation unit 13), and the adjuster (the adjusting unit 14). The image sensor 11 includes a plurality of pixels each to store electric charges and is configured to convert amounts of electric charges stored in the plurality of pixels into pixel values and output the pixel values. The light controller (the optical block 12) is configured to control an amount of light to be subjected to photoelectric conversion by the image sensor 11. The image generator (the image generation unit 13) is configured to read out the pixel values from the image sensor 11 at a predetermined frame rate and generate an image at the frame rate from the read-out pixel values. The adjuster (the adjusting unit 14) is configured to evaluate some or all of the pixel values of the image generated at the frame rate by an evaluation value defined as a numerical value and adjust the pixel values by controlling at least one of the light controller (the optical block 12) and the image generator (the image generation unit 13) so that the evaluation value falls within a predetermined appropriate range. The adjuster (the adjusting unit 14) is configured to, when the evaluation value of the image generated at the frame rate is deviated from the appropriate range by a predetermined level or more, set the image generator (the image generation unit 13) to an adjusting mode of generating an image at an adjustment frame rate higher than the frame rate (the normal frame rate), and after the image generator (the image generation unit 13) generates the image at the adjustment frame rate, set the image generator to a normal mode of generating the image at the frame rate (the normal frame rate).

Further, the object detection device 1 of the present embodiment may include any one of the following fifteenth to seventeenth features in addition to the fourteenth feature.

In the fifteenth feature, the adjuster (the adjusting unit 14) is configured to, when the evaluation value of the image generated in the adjusting mode falls within the appropriate range, return the image generator (the image generation unit 13) from the adjusting mode to the normal mode.

In the sixteenth feature, the adjuster (the adjusting unit 14) is configured to, when the number of images generated in the adjusting mode reaches the predetermined number of frames, return the image generator (the image generation unit 13) from the adjusting mode to the normal mode.

In the seventeenth feature, the adjuster (the adjusting unit 14) is configured to, when the elapsed time from the time of switching to the adjusting mode reaches the predetermined time, return the image generator (the image generation unit 13) from the adjusting mode to the normal mode.

Additionally, the object detection device 1 of the present embodiment may further include the following eighteenth to twenty-second features selectively.

In the eighteenth feature, the adjuster (the adjusting unit 14) is configured to, when the electric charge accumulating period adjusted by controlling the light controller (the optical block 12) in the normal mode exceeds the upper limit of the electric charge accumulating period in the adjusting mode, set the electric charge accumulating period in the adjusting mode to the upper limit thereof and control the light controller (the optical block 12) or the image generator (the image generation unit 13) to change parameters other than the electric charge accumulating period so as to adjust the pixel value.

In the nineteenth feature, the adjuster (the adjusting unit 14) is configured to, when the image generation unit 13 is returned to the normal mode, control the light controller (the optical block 12) to readjust the electric charge accumulating period. The adjuster (the adjusting unit 14) is configured to, when the readjusted electric charge accumulating period is different from the last electric charge accumulating period in the adjusting mode, control the light controller (the optical block 12) or the image generator (the image generation unit 13) to change parameters other than the electric charge accumulating period to adjust the pixel value.

In the twentieth feature, the adjuster (the adjusting unit 14) is configured to, in a case of controlling the image generator (the image generation unit 13) to increase and decrease the amplification for amplifying the pixel value in the adjusting mode, increase the upper limit of the amplification to be larger than the upper limit of the amplification in the normal mode.

In the twenty-first feature, the image generator (the image generation unit 13) is configured not to output the image generated in the adjusting mode.

In the twenty-second feature, the adjuster (the adjusting unit 14) is configured to control the image generator (the image generation unit 13) to read out only pixel values of some of pixels of the image sensor 11 in the adjusting mode.

As described above, according to the image sensing device 10 and the object detection device 1 of the present embodiment, in contrast to a case where the high frame rate is used in the normal mode, a period of the adjusting mode (adjustment period) causing an increase in the energy consumption becomes extremely short, and thus it is possible to improve the responsiveness of the adjustment of the exposure amount while suppressing increases in the energy consumption and the amount of heat generation.

### Embodiment 3

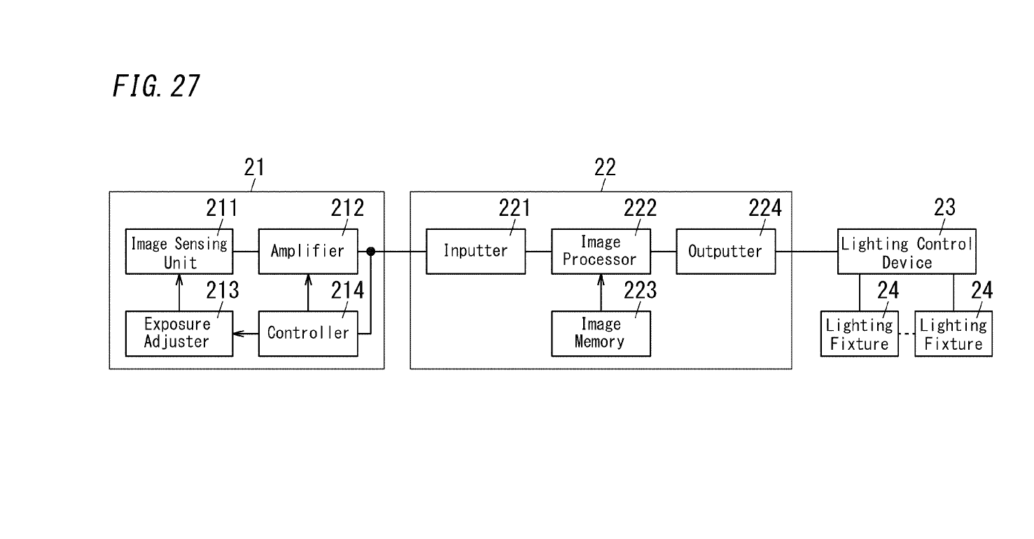

An object detection device 1 of the present embodiment includes an image sensing device 21 shown in FIG. 27 as a camera 2. Further, the object detection device 1 of the present embodiment includes an object detecting device 22 substantially the same as the image processing device of the embodiment 1. In other words, the present embodiment mainly relates to the image sensing device 21.

In the past, there has been proposed a lighting system which includes an image sensor for taking an image of a controlled region, a processor for determining a position of a person present in the controlled region from information of the image taken by the image sensor, and a controller for turning on and off a light source based on a result of calculation of the processor (see document 4 [JP 2011-108417 A]). The processor calculates an interframe difference between the images taken by the image sensor to determine a pixel whose luminance value has been changed between the frames, and therefore determines a position of an object to be processed, that is, a person.

A generally used image sensor is used for providing an image to be seen by a person. When a change in luminance of a subject is caused by some reasons, exposure adjustment of automatically adjusting an amount of exposure so that the luminance of the subject falls within a predetermined luminance range is immediately performed.

In the aforementioned lighting system, the position of the person is determined based on the interframe difference of the images taken by the image sensor. Therefore, when an amount of exposure is changed between the frames by the exposure adjustment, the luminance values of the pixels are also changed between the frames, and detection of a person is likely to be failed.

In view of the above insufficiency, the present embodiment has aimed to reduce an undesired effect on the image processing caused by the process of adjusting the luminance values of the pixels in response to a change in an amount of light in the image sensed area.

The image sensing device 21 takes an image of the preliminarily selected image sensed area. This image sensing device 21 includes, as shown in FIG. 27, an image sensing unit 211, an amplifier 212, an exposure adjuster 213, and a controller 214.

The image sensing unit 211 may include, for example, a solid-state image sensor such as a CCD image sensor and a CMOS image sensor, a lens for converging rays of light from the image sensed area to the solid-state image sensor, and an A/D converter for converting an analog output signal of the solid state image sensor into a digital image signal (image data). The image sensing unit 211 takes an image of an illuminated area of a lighting fixture 24 at a predetermined frame rate, and outputs the image data of this illuminated area constantly. Note that, the image data outputted from the image sensing unit 211 is image data of a greyscale image in which luminance of each pixel is represented in greyscale (e.g., 256 levels).

The amplifier 212 amplifies the luminance values of the individual pixels of the image data outputted from the image sensing unit 211 and outputs them to an external device (in the present embodiment, the object detecting device 22).

The exposure adjuster 213 changes exposure time of the image sensing unit 211 to adjust an exposure condition. Note that, in a case where the image sensing unit 211 includes a diaphragm for varying an F-ratio (aperture ratio), the exposure adjuster 213 may control the exposure condition by controlling the diaphragm to change the F-ratio, or may control the exposure condition by varying both the exposure time and the F-ratio.

The controller 214 calculates an average value of luminance values of a plurality of pixels of the image sensing unit 211 as the luminance evaluation value, and adjusts the exposure condition (the exposure time in the present embodiment) of the exposure adjuster 213 and the amplification of the amplifier 212 so that the luminance evaluation value is equal to a predetermined desired value.

The controller 214 varies the exposure condition and the amplification in order that the luminance evaluation value is equal to the predetermined desired value. However, the controller 214 may adjust the luminance evaluation value by varying only the exposure condition, or may adjust the luminance evaluation value by varying only the amplification.

Further, the controller 214 calculates, as the luminance evaluation value, an average value of the luminance values of the plurality of pixels included in a region to be evaluated. However, the controller 214 may calculate an average value for each of a plurality of sub regions divided from the region to be evaluated, and performs statistical processing on the calculated average values to calculate the luminance evaluation value. Alternatively, the controller 214 may calculate the luminance evaluation value representing the luminance values of the plurality of pixels by performing statistical processing other than averaging processing.

Further, the controller 214 has a function of varying a period (frame rate) for taking images by the image sensing unit 211. In the present embodiment, the controller 214 can switch the frame rate between 5 fps (frame per second) and 13.3 fps, and normally sets the frame rate to 5 fps.

This image sensing device 21 is used in a load control system (lighting control system) shown in FIG. 27. This load control system includes the aforementioned image sensing device 21, the object detecting device 22, a lighting control device 23, and the lighting fixture 24.

In this load control system, the image sensing device 21 is installed above (e.g., a ceiling) the illuminated space of the lighting fixture 24, so as to take an image of the lower illuminated space from the above.

The object detecting device 22 determines whether a detection target (e.g., a person) is present in a detection region (e.g., the illuminated area of the lighting fixture 24), based on the image taken by the image sensing device 21, and outputs a result of determination to the lighting control device 23. When receiving the result of detection indicative of the presence of the person from the object detecting device 22, the lighting control device 23 turns on the lighting fixture 24, and when receiving the result of detection indicative of the absence of the person from the object detecting device 22, the lighting control device 23 turns off the lighting fixture 24.

The object detecting device 22 includes an inputter 221, an image processor 222, an image memory 223, and an outputter 224.

The inputter 221 outputs, to the image processor 222, the image data inputted from the image sensing device 21 at the predetermined frame rate. The inputter 221 is equivalent to the image obtainer 3 of the embodiment 1.

The image memory 223 may be a large capacity volatile memory such as a DRAM (Dynamic Random Access Memory). Writing data in and reading data out the image memory 223 are controlled by the image processor 222. The image memory 223 may store the image data of one or more frames inputted from the image sensing device 21, data of difference image created in the process of the image processing, and the like, for example. The image memory 223 is equivalent to the image memory 5 of the embodiment 1.

The image processor 222 is a microcomputer specialized in the image processing, for example. The image processor 222 performs embedded program to realize the function of determination of whether a person is in the image represented by the image data.

When receiving the image signal from the inputter 221 at the predetermined frame rate, the image processor 222 imports the image of the previous frame from the image memory 223, and calculates an interframe difference to extract a pixel region in which the luminance value is changed by more than a predetermined threshold between the frames. For example, the image processor 222 compares an area of the extracted pixel region with a prescribed range set based on a size of a person to be present in an image to determine whether a person is present in the image sensed area, and outputs a result of determination to the outputter 224. Further, the image processor 222 stores the image data inputted from the inputter 221 in the image memory 223, and thus the image data of one or more frames is stored in the image memory 223.

The image processor 222 is equivalent to the processor 4 in the embodiment 1. The image processor 222 performs the same process as that of the processor 4 to determine whether a person is present in the image sensed area.

The outputter 224 has a function of communicating with the lighting control device 23 which is connected to the outputter 224 via a signal line. When receiving the result of determination indicative of the presence or absence of the person from the image processor 222, the outputter 224 transfers this result of determination to the lighting control device 23. The outputter 224 is equivalent to the outputter 6 of the embodiment 1.

The lighting control device 23 turns on and off the plurality of lighting fixtures 24 based on the result of determination received from the outputter 224 of the object detecting device 22.

When the result of determination indicative of the presence of the person is not inputted from the object detecting device 22, the lighting control device 23 turns off the lighting fixture 24 to be controlled. When the result of determination indicative of the presence of the person is inputted from the object detecting device 22, the lighting control device 23 turns on the lighting fixture 24 to be controlled. Thereafter, after a lapse of predetermined lighting continuation time from the time when input of the result of determination indicative of the presence of the person from the object detecting device 22 is stopped, the lighting control device 23 turns off the lighting fixture 24 to be controlled. In this case, the lighting fixture 24 is kept turned on while the person is present in the illuminated space, and therefore it is possible to ensure a necessary amount of light. When a person leaves from the illuminated space, the lighting fixture 24 is turned off at the time after a lapse of the predetermined lighting continuation time, and therefore wasted energy consumption can be reduced.

When the amount of light of the image sensed area is changed due to some reasons, with regard to the image to be seen by a person, it is necessary to rapidly adjust the luminance of the screen into a luminance range suitable for human eyes. However, in the present embodiment, the image of the image sensing device 21 is not used as an image to be seen by a person, but is used in the image processing for detection of moving objects, and therefore there is no need to adjust the luminance of the screen rapidly. When the luminance of the screen is rapidly changed by varying the exposure condition or the like, effects due to such a rapid change may cause incorrect detection of the moving object.

In view of this, in the present embodiment, when the luminance of the screen decreases or increases to an extent that the image processing for the detection of the moving object is impossible, the controller 214 varies the exposure condition of the exposure adjuster 213 and the amplification of the amplifier 212 to make the luminance evaluation value be equal to the predetermined desired value instantaneously. In contrast, even in a case where the luminance of the screen changes, as long as the luminance of the screen allows the image processing without any problem, the controller 214 gently varies the exposure condition and the amplification to make the luminance evaluation value be close to the predetermined desired value, in order to avoid undesired effects on the image processing of the detection of the moving object.

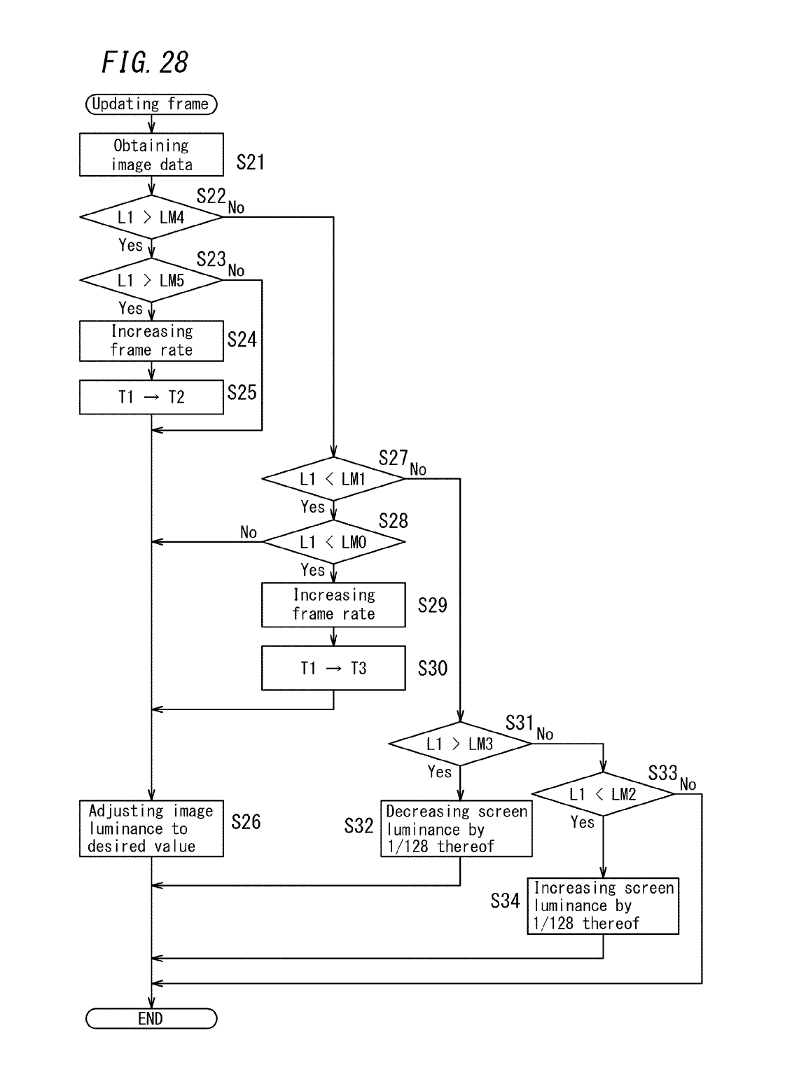

In this regard, operation in which the controller 214 adjusts the luminance value of the screen according to the luminance (the luminance evaluation value) of the screen is described with reference to a flow chart shown in FIG. 28.

The image sensing unit 211 takes images of the image sensed area at a predetermined frame rate (normally, 5 fps) and outputs the image data to the amplifier 212 each time the image sensing unit 211 takes an image of the image sensed area. When the image sensing unit 211 outputs the image data taken at the frame rate to the amplifier 212, the amplifier 212 amplifies the luminance values of the pixels of the image data by the predetermined amplification, and outputs the resultant luminance values to the object detecting device 22.

When importing the image data from the amplifier 212 at the frame rate (step S21 in FIG. 28), the controller 214 calculates the average value of the luminance values of the plurality of pixels and treats this average value as the luminance evaluation value L1.

When calculating the luminance evaluation value L1, the controller 214 calculates a difference between this luminance evaluation value L1 and the predetermined desired value T1, and adjusts the amplification of the amplifier 212 and the exposure condition of the exposure adjuster 213 to reduce this difference. In the present embodiment, the luminance value of each pixel is classified into 256 levels (0 to 255), and the desired value T1 of the luminance evaluation value L1 is normally 64.

The image sensing device 21 of the present embodiment is not used for taking an image to be seen by a person but is used for taking an image to be subjected to the image processing of the detection of the moving object by the object detecting device 22 at the later step. Therefore, if the luminance range provides an image which is too light or dark for humans but allows the image processing without any problem, the controller 214 limits amounts of adjustment of the exposure condition and the amplification in order that the luminance evaluation value L1 is not changed greatly due to adjustment of the exposure condition and the amplification. Hereinafter, operation of the controller 214 is described while a lower limit and an upper limit of the luminance range enabling the image processing without any problem are LM1 (e.g., 32) and LM4 (e.g., 128), respectively.

When calculating the luminance evaluation value L1 at step S21, the controller 214 compares the upper limit LM4 of the aforementioned luminance range with the luminance evaluation value L1 (step S22).

When the luminance evaluation value L1 exceeds the upper limit LM4 (Yes at step S22), the controller 214 further compares the luminance evaluation value L1 with the predetermined threshold (the second threshold) LM5 (e.g., 160) (step S23).

When the luminance evaluation value L1 is equal to or less than the threshold LM5, that is LM4<L1≦LM5 (No at step S23), the controller 214 varies the exposure time and the amplification so that the luminance evaluation value L1 is equal to the desired value T1 (step S26).

In contrast, when the luminance evaluation value L1 exceeds the threshold LM5 (Yes at step S23), the controller 214 increases the frame rate up to 13.3 fps (step S24) and switches the desired value T1 of the luminance evaluation value L1 to a value T2 (e.g., 56) smaller than a default value (step S25).

After increasing the frame rate and switching the desired value to the value T2 smaller than the default value, the controller 214 varies the exposure time and the amplification so that the luminance evaluation value L1 becomes equal to the desired value T2 (step S26), and thus the luminance evaluation value L1 is adjusted to the desired value T2 in short time (the next frame).

Note that, when the luminance evaluation value L1 exceeds the upper limit LM4, the controller 214 does not perform a process of limiting the amounts of adjustment of the exposure time and the amplification for limiting a change rate of the luminance evaluation value L1 to not more than a reference value described later, and thus adjusts the exposure time and the amplification so that the luminance evaluation value L1 becomes equal to the desired value instantaneously. Consequently, the controller 214 can make the luminance evaluation value L1 be equal to the desired value in short time, and therefore it is possible to shorten time necessary for enabling the desired image processing.

Further, at step S22, when the luminance evaluation value L1 is less than the upper limit LM4 (No at step S22), the controller 214 compares the lower limit LM1 of the aforementioned luminance range with the luminance evaluation value L1 (step S27).

When the luminance evaluation value L1 falls below the lower limit LM1 (Yes at step S27), the controller 214 further compares the luminance evaluation value L1 with the predetermined threshold (the first threshold) LM0 (e.g., 28) (step S28).

When the luminance evaluation value L1 is equal to or more than the threshold LM0, that is LM0≦L1<LM1 (No at step S28), the controller 214 varies the exposure time and the amplification so that the luminance evaluation value L1 becomes equal to the desired value T1 (step S26).

In contrast, when the luminance evaluation value L1 is less than the threshold LM0 (Yes at step S28), the controller 214 increases the frame rate up to 13.3 fps (step S29) and switches the desired value T1 of the luminance evaluation value L1 to a value T3 (e.g., 104) larger than the default value (step S30).

After increasing the frame rate and switching the desired value to the value T3 larger than the default value, the controller 214 varies the exposure time and the amplification so that the luminance evaluation value L1 becomes equal to the desired value T3 (step S26), and thus the luminance evaluation value L1 is adjusted to the desired value T3 in short time (the next frame).

Note that, when the luminance evaluation value L1 falls below the lower limit LM1, the controller 214 does not perform the process of limiting the amounts of adjustment of the exposure time and the amplification for limiting a change rate of the luminance evaluation value L1 to not more than the reference value described later, and thus adjusts the exposure time and the amplification so that the luminance evaluation value L1 becomes equal to the desired value instantaneously. Consequently, the controller 214 can make the luminance evaluation value L1 be equal to the desired value in short time, and therefore it is possible to shorten time necessary for enabling the desired image processing.

Further, at step S27, when the luminance evaluation value L1 is equal to or more than the lower limit LM1 (No at step S27), the controller 214 compares the luminance evaluation value L1 with the predetermined threshold LM3 (e.g., 66) (step S31).

When the luminance evaluation value L1 is more than the threshold LM3, that is, LM3<L1≦LM4 (Yes at step S31), the controller 214 varies the exposure time and the amplification so that the luminance value is decreased by 1/128 of the luminance value, and thereby slightly adjusts the luminance evaluation value L1 (step S32).

Further, at step S31, when the luminance evaluation value L1 is equal to or less than the threshold LM3 (No at step S31), the controller 214 compares the luminance evaluation value L1 with the threshold LM2 (e.g., 62) (step S33).

When the luminance evaluation value L1 is less than the threshold LM2, that is, LM1≦L1<LM2 (Yes at step S33), the controller 214 varies the exposure time and the amplification so that the luminance value is increased by 1/128 of the luminance value, and thereby slightly adjusts the luminance evaluation value L1 (step S34).

Further, at step S33, when the luminance evaluation value L1 is equal to or more than the threshold LM2, that is, LM2≦L1≦LM3, the controller 214 determines that the luminance evaluation value L1 is almost equal to the desired value T1, and ends the process without varying the exposure time and the amplification.

Note that, when the luminance evaluation value L1 exceeds the threshold LM5, the controller 214 increases the frame rate. However, when the luminance evaluation value L1 exceeds the upper limit LM4, the controller 214 may increase the frame rate.

Further, when the luminance evaluation value L1 exceeds the threshold LM5, the controller 214 switches the desired value to the value T2 smaller than the default value. However, when the luminance evaluation value L1 exceeds the upper limit LM4, the controller 214 may switch the desired value to the value T2 smaller than the default value.

Further, when the luminance evaluation value L1 falls below the threshold LM0, the controller 214 increases the frame rate. However, when the luminance evaluation value L1 falls below the lower limit LM1, the controller 214 may increase the frame rate.

Further, when the luminance evaluation value L1 falls below the threshold LM0, the controller 214 switches the desired value to the value T3 larger than the default value. However, when the luminance evaluation value L1 falls below the lower limit LM1, the controller 214 may switch the desired value to the value T3 larger than the default.

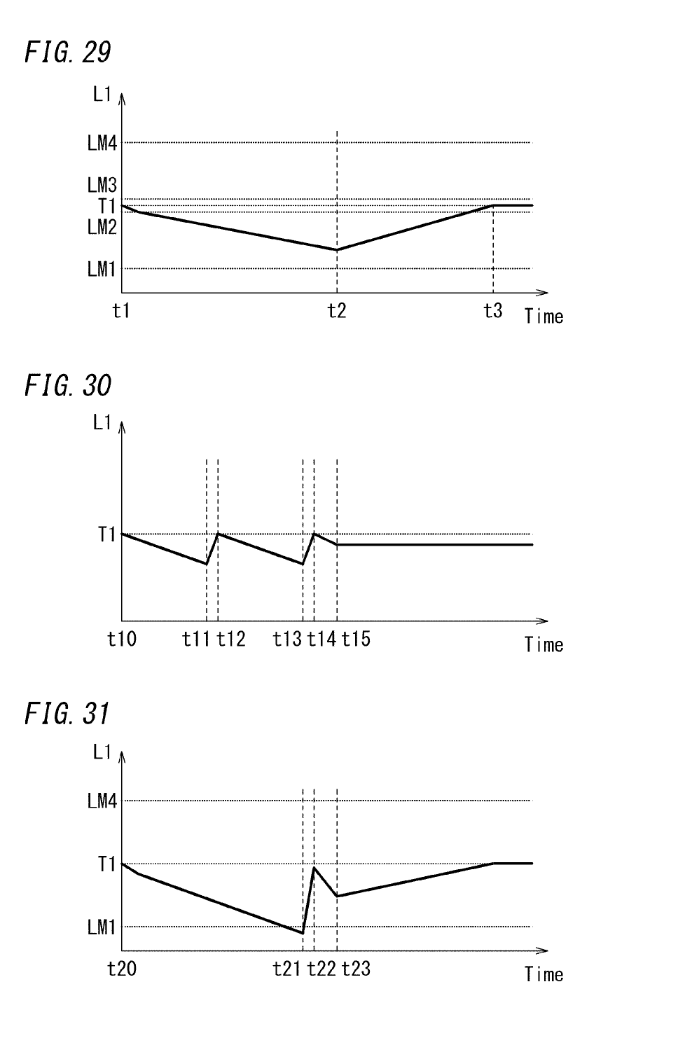

The adjustment process of the luminance of the screen by the controller 214 is as noted above. The operation in which the controller 214 adjusts the luminance of the screen based on the luminance evaluation value L1 is described in detail with reference to FIG. 29 to FIG. 35.

FIG. 29 illustrates an adjustment operation for a case where the luminance evaluation value L1 falls within the luminance range enabling the image processing without any problem, that is, a case where the luminance evaluation value L1 is equal to or more than the lower limit LM1 and is equal to or less than the upper limit LM4.

When the luminance evaluation value L1 is equal to or more than the lower limit LM1 and is less than the threshold LM2, the controller 214 varies the exposure time and the amplification to increment the luminance value by 1/128 of the luminance value every time a new frame comes, and thereby makes the luminance evaluation value L1 be gradually close to the desired value T1. Further, when the luminance evaluation value L1 is equal to or more than the threshold LM3 and is less than the upper limit LM4, the controller 214 varies the exposure time and the amplification to decrement the luminance value by 1/128 of the luminance value every time a new frame comes, and thereby makes the luminance evaluation value L1 be gradually close to the desired value T1.

In the example shown in FIG. 29, throughout the time period from the time t1 to the time t2, the lighting fixture 24 is faded out, and therefore the luminance of the screen is gradually decreased. In this time period, the controller 214 adjusts the exposure time and the amplification so as to increment the luminance value by 1/128 of the luminance value every time a new frame comes. However, the speed of decreasing the luminance of the screen by fading-out is more than the speed of increasing the luminance value by the controller 214, and therefore the adjustment of the exposure time and the amplification could not compensate such a decrease. Consequently, the luminance of the screen gradually decreases.

After the lighting fixture 24 is turned off completely at the time t2, the controller 214 varies the exposure time and the amplification to increment the luminance value by 1/128 of the luminance value every time a new frame comes. Consequently, the luminance evaluation value L1 gradually increases and becomes equal to the desired value T1 at the time t3.

As described above, when the luminance evaluation value L1 falls within the luminance range enabling the image processing without any problem, the controller 214 varies the exposure time and the amplification so that the change rate of the luminance evaluation value L1 does not exceed the predetermined reference value (e.g., 1/128 of the luminance value per one frame). Therefore, even when the luminance evaluation value L1 is changed with changes in the exposure time and the amplification, the change rate is kept not more than the predetermined reference value. Accordingly, it is possible to perform the image processing by use of the image data after adjustment of the luminance value without any problem.

Note that, the luminance value of the present embodiment is classified into 256 levels. When the controller 214 varies the exposure condition and the amplification so that the change rate of the luminance value does not exceed 1/128 of the luminance value per one frame, a change in the luminance value between the frames caused by adjustment of the exposure condition and the amplification is 2 or less. As described above, a change in the luminance value caused by adjustment of the exposure condition and the amplification becomes gradual, and therefore it is possible to reduce an effect caused by the process of adjusting the luminance value on the image processing using the image data, and thus the image processing can be performed without any problem.

Further, FIG. 30 shows an operation of adjusting the luminance of the screen for a case of taking an image to be seen by a person. In this operation example, the change rate of the luminance value caused by changes in the exposure time and the amplification is not limited. In this operation example, throughout the period from the time t10 to the time t15, the lighting fixture 24 is faded out and thus the luminance of the screen gradually decreases, for example.

When, at the time t11 and the time t13, the luminance evaluation value L1 decreases out of the luminance range suitable for images to be seen by persons, the controller 214 adjusts the exposure condition and the amplification so that the luminance evaluation value L1 of the next frame becomes equal to the desired value T1. In this case, in the time period from the time t11 to the time t12 and the time period from the time t13 to the time t14, the luminance of the screen changes rapidly. Hence, it is difficult to distinguish this rapid change from the change in the luminance caused by the presence of the moving object, and the image processing for detection of the moving object is hard to perform.

In contrast, according to the present embodiment, when the luminance evaluation value L1 falls within the luminance range enabling the image processing without any problem, the controller 214 limits the change rate of the luminance value caused by changes in the exposure time and the amplification to 1/128 of the luminance value, and thereby reduces a change in the luminance value. Therefore, it is possible to reduce a change in the luminance value caused by changes in the exposure condition and the amplification to an extent that the image processing is not inhibited, and thus the image processing can be performed without any problem.

FIG. 31 shows an operation for a case where the luminance evaluation value L1 falls below the lower limit LM1 of the luminance range enabling the image processing without any problem. Throughout the time period from the time t20 to the time t23, for example, the lighting fixture 24 is faded out, and therefore the amount of light in the image sensed region is gradually decreased.

In the time period from the time t20 to the time t21, the controller 214 adjusts the exposure time and the amplification so as to increment the luminance value by 1/128 of the luminance value every time a new frame comes. However, the speed of decreasing the luminance of the screen by fading-out is more than the speed of increasing the luminance value by the controller 214, and therefore the adjustment of the exposure time and the amplification could not compensate such a decrease. Consequently, the luminance of the screen gradually decreases.

Note that, the controller 214 adjusts the exposure condition and the amplification so that the change rate of the luminance value is equal to or less than the predetermined reference value, and thereby makes the luminance evaluation value L1 be close to the desired value T1. Consequently, a change in the luminance value caused by the adjustment process is reduced, and the image processing can be performed without any problem.

In contrast, when the luminance evaluation value L1 falls below the lower limit LM1 at the time t21, the controller 214 changes the exposure time and the amplification so that the luminance evaluation value L1 of the next frame is equal to the desired value T1. In this regard, the luminance value is greatly changed between the frame (the time t21) whose luminance evaluation value L1 falls below the lower limit LM1 and the next frame (the time t22), and therefore the image processing for detection of the moving object is difficult. However, after the time t22, the luminance evaluation value L1 becomes equal to or more than the lower limit LM1 and equal to or less than the upper limit LM4, and therefore the change rate of the luminance value caused by changes in the exposure time and the amplification is limited to 1/128 of the luminance value. Consequently, the image processing can be performed without any problem.

Subsequently, the controller 214 continues to adjust the exposure time and the amplification so as to increment the luminance value by 1/128 of the luminance value every time a new frame comes. However, in the time period from the time t22 to the time t23, the speed of decreasing the luminance of the screen by fading-out is more than the speed of increasing the luminance value by the controller 214, and therefore the luminance of the screen gradually decreases. After the lighting fixture 24 is turned off completely at the time t23, the controller 214 varies the exposure time and the amplification to increment the luminance value by 1/128 of the luminance value every time a new frame comes. Consequently, the luminance evaluation value L1 starts to increase, and is finally equal to the desired value T1.

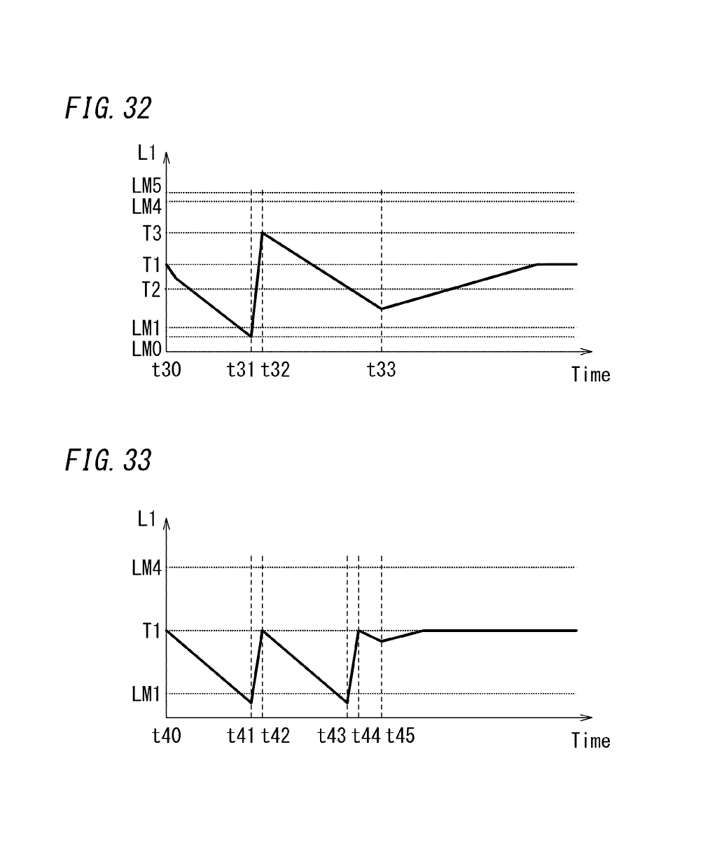

Further, FIG. 32 shows an operation for a case where the luminance evaluation value L1 falls below the predetermined threshold LM0 lower than the lower limit of the luminance range enabling the image processing without any problem. Throughout the time period from the time t30 to the time t33, for example, the lighting fixture 24 is faded out, and therefore the amount of light in the image sensed region is gradually decreased.

In the time period from the time t30 to the time t31, the controller 214 adjusts the exposure time and the amplification so as to increment the luminance value by 1/128 of the luminance value every time a new frame comes. However, the speed of decreasing the luminance of the screen by fading-out is more than the speed of increasing the luminance value by the controller 214. Consequently, the luminance of the screen gradually decreases.

When the luminance evaluation value L1 falls below the threshold LM0 lower than the lower limit LM1 at the time t31, the controller 214 increases the frame rate from 5 fps to 13.3 fps, and switches the desired value T1 to a larger value T3 (=104). Thereafter, the controller 214 varies the exposure time and the amplification so that the luminance evaluation value L1 of the next frame becomes equal to the desired value T3.

In this regard, the luminance value is greatly changed between the frame (the time t31) whose luminance evaluation value L1 falls below the threshold LM0 and the next frame (the time t32), and therefore the image processing for detection of the moving object is difficult. However, after the time t32, the luminance evaluation value L1 becomes equal to or more than the lower limit LM1 and equal to or less than the upper limit LM4, and therefore the change rate of the luminance value caused by changes in the exposure time and the amplification is limited to 1/128 of the luminance value. Consequently, the image processing can be performed without any problem. Note that, when the luminance evaluation value L1 falls within the luminance range enabling the image processing without any problem (equal to or more than the lower limit LM1 and equal to or less than the upper limit LM4), the controller 214 resets the frame rate and the desired value to their default values.

Thereafter, the controller 214 continues to adjust the exposure time and the amplification so as to increment the luminance value by 1/128 of the luminance value every time a new frame comes. However, in the time period from the time t32 to the time t33, the speed of decreasing the luminance of the screen by fading-out is more than the speed of increasing the luminance value by the controller 214, and therefore the luminance of the screen gradually decreases. After the lighting fixture 24 is turned off completely at the time t33, the controller 214 varies the exposure time and the amplification to increment the luminance value by 1/128 of the luminance value every time a new frame comes. Consequently, the luminance evaluation value L1 starts to increase, and is finally equal to the desired value T1.

In this regard, FIG. 33 shows the adjustment operation for a case of not varying the desired value T1. Throughout the time period from the time t40 to the time t45, the lighting fixture 24 is faded out, and accordingly the amount of light in the image sensed area is gradually decreased.

In the time period from the time t40 to the time t41, the controller 214 adjusts the exposure time and the amplification so as to increment the luminance value by 1/128 of the luminance value every time a new frame comes. However, the speed of decreasing the luminance of the screen by fading-out is more than the speed of increasing the luminance value by the controller 214. Consequently, the luminance of the screen gradually decreases. When the luminance evaluation value L1 falls below the lower limit LM1 at the time t41, the controller 214 varies the exposure time and the amplification to adjust the luminance value so that the luminance evaluation value L1 becomes equal to the desired value T1.

However, in the illustrated example, the speed of decreasing the luminance evaluation value L1 by fading-out is more than the speed of increasing the luminance evaluation value V1 by the controller 214, and therefore the luminance of the screen gradually decreases. Consequently, at the time t43, the luminance evaluation value L1 falls below the lower limit LM1 again. In view of this, at the time t43, the controller 214 varies the exposure time and the amplification so that the luminance evaluation value L1 becomes equal to the desired value T1. Consequently, in both the time period from the time t41 to the time t42 and the time period from the time t43 to the time t44, the image processing for detection of the moving object cannot be performed.

In contrast, in the present embodiment, when the luminance evaluation value L1 falls below the threshold LM0 lower than the lower limit LM1, the controller 214 switches the desired value of the luminance evaluation value L1 to the larger value T2. Therefore, time necessary for the luminance evaluation value L1 to decrease due to the fading-out and then fall below the lower limit LM1 from the time when the luminance evaluation value L1 is adjusted to the desired value T2 becomes longer than that in a case of not changing the desired value.

In the operation example shown in FIG. 32, after the exposure time and the amplification are adjusted so that the luminance evaluation value L1 becomes equal to the desired value T2 at the time t31, the luminance evaluation value L1 does not fall below the lower limit LM1 until the time t33 in which the fading-out is ended. Therefore, the number of times of adjusting, by the controller 214, the exposure time and the amplification so that the luminance value becomes equal to the desired value decreases, and therefore it is possible to shorten a time period in which the image processing cannot be performed due to adjustment of the luminance of the screen.

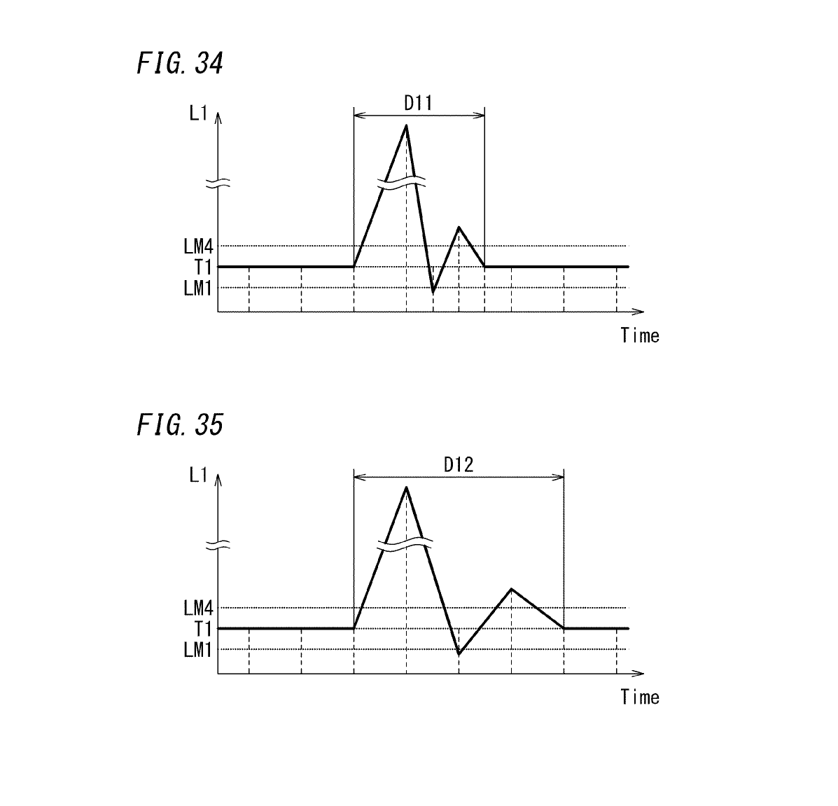

Further, FIG. 34 shows the adjustment operation for a case where the frame rate is increased when the luminance evaluation value L1 goes out of the luminance range enabling the image processing without any problem. FIG. 35 shows the adjustment operation for a case of not changing the frame rate. As shown in FIG. 35, when the frame rate is constant, once the luminance evaluation value L1 goes out of the luminance range enabling the image processing without any problem, relatively long time D12 is necessary for the luminance evaluation value L1 to fall within the aforementioned luminance range. In this time, the luminance value would be greatly changed, and therefore the image processing cannot be performed.

In contrast, in the present embodiment, when the luminance evaluation value L1 goes out of the luminance range enabling the image processing without any problem, the controller 214 increases the frame rate, and therefore the time D11 necessary for making the luminance evaluation value L1 fall within the aforementioned luminance range can be shorter than that in a case where the frame rate is constant. Consequently, the time period when the luminance evaluation value L1 is not suitable for the image processing is shortened, and it is possible to restart the image processing earlier.

Note that, values of the aforementioned thresholds LM0 to LM5 may be appropriately changed in accordance with the methods of the image processing or the like.

As described above, the image sensing device 21 of the present embodiment includes: the image sensing unit 211 configured to take an image of the image sensed area at the predetermined frame rate; the exposure adjuster 213 configured to adjust the exposure condition of the image sensing unit 211; the amplifier 212 configured to amplify the luminance values of the plurality of pixels of the image data outputted from the image sensing unit 211 and output the amplified luminance values to the external device; and the controller 214 configured to adjust at least one of the exposure condition of the exposure adjuster 213 and the amplification of the amplifier 212 so that the luminance evaluation value calculated by performing the statistical processing on the luminance values of the plurality of pixels of the image data becomes equal to the predetermined desired value. The controller 214 is configured to limit an amount of adjustment so that the change rate of the luminance evaluation value caused by the adjustment of at least one of the exposure condition and the amplification becomes equal to or less than the predetermined reference value, when the luminance evaluation value falls within the luminance range enabling the image processing on the image data outputted from the amplifier 212, and is configured not to limit the amount of the adjustment when the luminance evaluation value is out of the aforementioned luminance range.

In other words, the object detection device 1 of the present embodiment includes the following twenty-third feature in addition to the aforementioned first feature. Note that, the object detection device 1 of the present embodiment may include the aforementioned second to thirteenth features selectively.

In the twenty-third feature, the object detection device 1 includes the image sensing device 21 serving as the camera 2. The image sensing device 21 includes the image sensing unit 211, the exposure adjuster 213, the amplifier 212, and the controller 214. The image sensing unit 211 is configured to take an image of an image sensed area at a predetermined frame rate. The exposure adjuster 213 is configured to adjust an exposure condition for the image sensing unit 211. The amplifier 212 is configured to amplify luminance values of individual pixels of image data outputted from the image sensing unit 211 and output the resultant luminance values. The controller 214 is configured to adjust at least one of the exposure condition of the exposure adjuster 213 and an amplification factor of the amplifier 212 so that a luminance evaluation value calculated by statistical processing on the luminance values of the individual pixels of the image data is equal to a predetermined intended value. The controller 214 is configured to, when the luminance evaluation value falls within a luminance range in which image processing on image data outputted from the amplifier 212 is possible, limit an amount of adjustment so that a ratio of change in the luminance evaluation value caused by adjustment of at least one of the exposure condition and the amplification factor is equal to or less than a predetermined reference value, and being configured to, when the luminance evaluation value is out of the luminance range, not limit the amount of adjustment.

Accordingly, the controller 214 limits the amount of adjustment so that the change rate of the luminance evaluation value caused by the adjustment of at least one of the exposure condition and the amplification becomes equal to or less than the predetermined reference value, when the luminance evaluation value falls within the luminance range enabling the image processing on the image data. Therefore it is possible to reduce an unwanted effect caused by the process of adjustment of the luminance of the image on the image processing.

Further, the controller 214 is configured not to limit the amount of the adjustment when the luminance evaluation value is out of the aforementioned luminance range. Therefore, it is possible to make the luminance evaluation value be equal to the desired value at short time, and thus to shorten time necessary for enabling the desired image processing. Note that, the luminance range enabling the image processing on the image data may be defined as a luminance range except another luminance range in which the image processing cannot be performed due to an excessively low luminance value and another luminance range in which the image processing cannot be performed due to an excessively high luminance value.

Further, the object detection device 1 of the present embodiment may include any one of the following twenty-fourth to thirty-second features in addition to the twenty-third feature.

In the twenty-fourth feature, the controller 214 is configured to, when the luminance evaluation value L1 falls below the lower limit of the aforementioned luminance range (equal to or more than the lower limit LM1 and equal to or less than the upper limit LM4), increase the desired value more than that in a case where the luminance evaluation value L1 falls within the aforementioned luminance range.

Accordingly, when the luminance evaluation value L1 decreases and falls below the aforementioned luminance range, the luminance evaluation value L1 is adjusted to the desired value set to be greater than that in a case where the luminance evaluation value L1 falls within the luminance range. Therefore, when the luminance evaluation value L1 continues to decrease thereafter, time necessary for the luminance evaluation value L1 to fall below the aforementioned luminance range again becomes longer.

In the twenty-fifth feature, the controller 214 is configured to, when the luminance evaluation value L1 falls below the predetermined threshold LM0 lower than the lower limit of the aforementioned luminance range, increase the desired value to be greater than that in a case where the luminance evaluation value L1 is equal to or more than the threshold LM0.

Accordingly, when the luminance evaluation value L1 decreases and falls below the threshold LM0, the luminance evaluation value L1 is adjusted to the desired value set to be greater than that in a case where the luminance evaluation value L1 is equal to or more than the threshold LM0. Therefore, when the luminance evaluation value L1 continues to decrease thereafter, it is possible to prolong time necessary for the luminance evaluation value L1 to fall below the aforementioned luminance range again.

In the twenty-sixth feature, the controller 214 is configured to, when the luminance evaluation value L1 falls below the lower limit of the aforementioned luminance range, increase the frame rate to be greater than that in a case where the luminance evaluation value L1 falls within the aforementioned luminance range.

Accordingly, it is possible to shorten time necessary for the luminance evaluation value L1 to fall within the aforementioned luminance range, and to shorten the time period in which the luminance evaluation value L1 varies according to the adjustment operation of the controller 214. Therefore, time in which the image processing cannot be performed can be shortened.

In the twenty-seventh feature, the controller 214 is configured to, when the luminance evaluation value L1 falls below the predetermined threshold LM0 lower than the lower limit of the aforementioned luminance range, increase the frame rate to be greater than that in a case where the luminance evaluation value L1 is equal to or more than the threshold LM0.

Accordingly, it is possible to shorten time necessary for the luminance evaluation value L1 to fall within the aforementioned luminance range, and to shorten the time period in which the luminance evaluation value L1 varies according to the adjustment operation of the controller 214. Therefore, time in which the image processing cannot be performed can be shortened.

In the twenty-eighth feature, the controller 214 is configured to, when the luminance evaluation value L1 exceeds the upper limit of the aforementioned luminance range, decrease the desired value to be smaller than that in a case where the luminance evaluation value L1 falls within the aforementioned luminance range.

Accordingly, when the luminance evaluation value L1 increases and exceeds the upper limit of the aforementioned luminance range, the luminance evaluation value L1 is adjusted to the desired value set to be smaller than that in a case where the luminance evaluation value L1 falls within the luminance range. Therefore, when the luminance evaluation value L1 continues to increase thereafter, it is possible to prolong time necessary for the luminance evaluation value L1 to exceed the upper limit of the aforementioned luminance range again.

In the twenty-ninth feature, the controller 214 is configured to, when the luminance evaluation value L1 exceeds the predetermined threshold LM5 higher than the upper limit of the aforementioned luminance range, decrease the desired value to be smaller than that in a case where the luminance evaluation value L1 is equal to or less than the predetermined threshold LM5.

Accordingly, when the luminance evaluation value L1 increases and exceeds the threshold LM5, the luminance evaluation value L1 is adjusted to the desired value set to be smaller than that in a case where the luminance evaluation value L1 is equal to or less than the threshold LM5. Therefore, when the luminance evaluation value L1 continues to increase thereafter, it is possible to prolong time necessary for the luminance evaluation value L1 to exceed the upper limit of the aforementioned luminance range again.

In the thirtieth feature, the controller 214 is configured to, when the luminance evaluation value L1 exceeds the upper limit of the aforementioned luminance range, increase the frame rate to be higher than that in a case where the luminance evaluation value L1 falls within the aforementioned luminance range.

Accordingly, it is possible to shorten time necessary for the luminance evaluation value L1 to fall within the aforementioned luminance range, and to shorten the time period in which the luminance evaluation value L1 varies according to the adjustment operation of the controller 214. Therefore, time in which the image processing cannot be performed can be shortened.

In the thirty-first feature, the controller 214 is configured to, when the luminance evaluation value L1 exceeds the predetermined threshold LM5 higher than the upper limit of the aforementioned luminance range, increase the frame rate to be higher than that in a case where the luminance evaluation value L1 is equal to or less than the predetermined threshold LM5.

Accordingly, it is possible to shorten time necessary for the luminance evaluation value L1 to fall within the aforementioned luminance range, and to shorten the time period in which the luminance evaluation value L1 varies according to the adjustment operation of the controller 214. Therefore, time in which the image processing cannot be performed can be shortened.

In the thirty-second feature, further, the controller 214 is configured to, when the luminance evaluation value L1 falls below the predetermined first threshold LM0 lower than the lower limit of the aforementioned luminance range, increase the desired value and the frame rate to be more than those in a case where the luminance evaluation value L1 is equal to or more than the first threshold LM0. The controller 214 is configured to, when the luminance evaluation value L1 exceeds the predetermined second threshold LM5 higher than the upper limit of the aforementioned luminance range, decrease the desired value to be less than that and increase the frame rate to be more than that in a case where the luminance evaluation value L1 is equal to or less than the second threshold LM5.

Accordingly, when the luminance evaluation value L1 decreases and falls below the first threshold LM0, the luminance evaluation value L1 is adjusted to the desired value set to be more than that in a case where the luminance evaluation value L1 is equal to or more than the first threshold LM0. Therefore, when the luminance evaluation value L1 continues to decrease thereafter, it is possible to prolong time necessary for the luminance evaluation value L1 to fall below the lower limit of the aforementioned luminance range again.

Further, when the luminance evaluation value L1 increases and exceeds the second threshold LM5, the luminance evaluation value L1 is adjusted to the desired value set to be less than that in a case where the luminance evaluation value L1 is equal to or less than the second threshold LM5. Therefore, when the luminance evaluation value L1 continues to increase thereafter, it is possible to prolong time necessary for the luminance evaluation value L1 to exceed the upper limit of the aforementioned luminance range again.

Further, when the luminance evaluation value L1 falls below the first threshold LM0 or exceeds the second threshold LM5, the controller 214 increases the frame rate, and therefore it is possible to shorten time necessary for the luminance evaluation value L1 to fall within the aforementioned luminance range. Consequently, it is possible to shorten the time period in which the luminance evaluation value L1 varies according to the operation of adjusting the luminance value by the controller 214, and thus the time in which the image processing cannot be performed can be shortened.

### Embodiment 4

The present embodiment relates to a motion sensor for detecting a person in a detection area, and a load control system for controlling at least one load based on a result of detection of a motion sensor.

In the past, there has been proposed an infrared sensor attached automatic switch disclosed in document 5 (JP 2008-270103 A) as a motion sensor and a load control system, for example. The switch disclosed in document 5 detects an infrared radiation from a human body by a pyroelectric element and determines whether a person is present based on a change in the infrared radiation detected by the pyroelectric element, and controls an amount of light emitted from a lighting load.

However, in the background art disclosed in document 5, when a person is at rest, an infrared radiation detected by the pyroelectric element does not change, and therefore the person cannot be detected. Further, in order to control loads according to presence or absence of persons with regard to divided detection regions, the background art disclosed in document 5 requires installing motion sensors (infrared sensor attached switches) on every divided detection regions.

In view of the above insufficiency, the present embodiment has aimed to enable detection of a person at rest and detection of a person with regard to each of a plurality of regions.

Hereinafter, the motion sensor (the object detection device) 31 and the load control system of the embodiment in accordance with the present embodiment are described in detail with reference to corresponding drawings. Note that, the present embodiment relates to the load control system for controlling lighting loads. However, the load to be controlled by the load control system is not limited to a lighting load and may be an air conditioning load (an air conditioner for adjusting a temperature and humidity in a room), for example.

As shown in FIG. 37, the load control system of the present embodiment includes the motion sensor 31, a control device 32, and a plurality of lighting loads 33.

The control device 32 generates a control command for each lighting load 33 according to person detection information (described later) sent from the motion sensor 31 through a transmission line, and sends the generated control command to each lighting load 33 through a signal line.

The lighting load 33 includes: a light source (not shown) such as an incandescent lamp, a fluorescent lamp, or an LED lamp; and a lighting device (not shown) for turning on and off and dimming the light source according to the control command. The lighting load 33 is placed on a ceiling of an illuminated space (e.g., a floor of an office building).

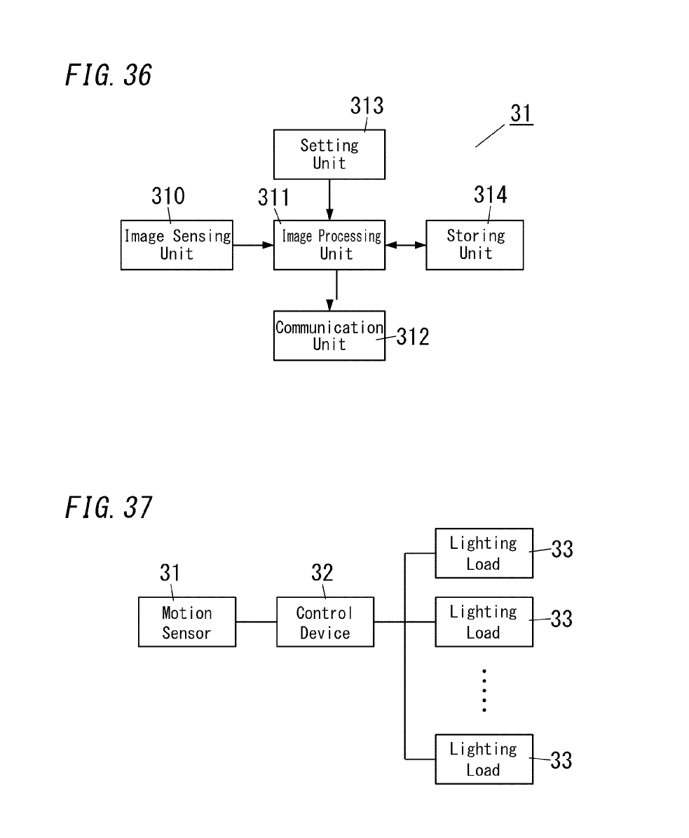

As shown in FIG. 36, the motion sensor 31 may include an image sensing unit 310, an image processing unit 311, a communication unit 312, a setting unit 313, and a storing unit 314, for example.

The image sensing unit 310 includes: an image sensor such as a CMOS image sensor and a CCD image sensor; a lens; and an A/D converter for converting an analog output signal from the image sensor into a digital image signal (image data). The image sensing unit 310 may be the camera 2 of the embodiment 1, the image sensing device 10 of the embodiment 2, or the image sensing device 21 of the embodiment 3.

The storing unit 314 may be a rewritable non-volatile semiconductor memory such as a flash memory. As described later, the storing unit 314 stores various types of information necessary for the image processing and the determination process executed by the image processing unit 311.

The communication unit 312 performs data transmission with the control device 32 via a transmission line.

The setting unit 313 may be a switch for setting various types of information to be stored in the storing unit 314, or an interface for receiving the information given by a configurator not shown.

Note that, the motion sensor 31 is installed in a location allowing taking an image of an entire illuminated space to be illuminated by the lighting load 33. Such a location may be a ceiling or a wall of an illuminated space, for example.

The image processing unit 311 is realized by use of a microcomputer or a DSP. The image processing unit 311 performs various types of image processing on the image data imported from the image sensing unit 310 and performs the determination process of whether a person is present based on a result of the image processing.

For example, the data of the image of a detection region taken under a condition where no person is present in the detection region (illuminated space) is stored in the storing unit 314 as background image data. The image processing unit 311 calculates a difference between the data of the image of the detection region imported from the image sensing unit 310 and the data of the background image, and tries to detect a pixel region (hereinafter referred to as a human body pixel region) corresponding to an edge of a person or a region of a person from such a difference image, and determines that a person is present when detecting the human body pixel region. Note that, the human body pixel region can be detected from an interframe difference instead of the background difference.

Further, the image processing unit 311 calculates a representative position in the human body pixel region, and compares a moving distance of the representative position within predetermined time (time corresponding to predetermined number of frames) with a threshold to determine an action of a person (e.g., staying, resting, and moving). For example, when the distance is less than the threshold, it is determined that the person stays at the same place or is at rest. When the distance is equal to or more than the threshold, it is determined that the person is in motion. In this regard, the representative position may be a position of a center of gravity of the human body pixel region or a position of a particular part (e.g., a head) of a human body. Note that, in a case where a person is at rest, there is a possibility that the human body pixel region cannot be detected by a detection method using interframe differences. However, the detection method using background differences may enable detection of the human body pixel region in such a case.

Further, the image processing unit 311 determines the position (coordinates) and the number (the number of persons) of detected human body pixel regions. Note that, a result of such determination which indicates presence or absence of persons in the detection regions, the number, the positions, and the actions (e.g., staying, resting, and moving) of present persons is sent as the information (human detection information) from the communication unit 312 to the control device 32 through the transmission line.

For example, the image processing unit 311 includes an image obtainer 3, a processor 4, an image memory 5, and an outputter 6 as with the embodiment 1. Note that, in the present embodiment, explanations of the image obtainer 3, the processor 4, the image memory 5, and the outputter 6 are omitted.

The control device 32 controls the lighting loads 33 according to the human detection information received from the motion sensor 31. For example, the control device 32 provides the control command to a lighting load 33 which is of the plurality of lighting loads 33 and corresponds to an illuminated area covering a present position of a person, and thereby turns it on at full power. The control device 32 provides the control command to a lighting load 33 which is of the plurality of lighting loads 33 and corresponds to an illuminated area not covering a present position of a person, and thereby turns it off or operates it at a dimming rate lower than that of the full power (100%). Further, while a person is in motion, the control device 32 provides the control command in order to operate the lighting load 33 at a relatively low dimming rate. While a person is at rest, the control device 32 provides the control command in order to operate the lighting load 33 corresponding to a stay location (present position of a person) at full power.

In this regard, each pixel value of the image data imported from the image sensing unit 310 corresponds to an amount of light in the detection region, and therefore the image processing unit 311 can determine an amount of light (illuminance) in the detection region from the pixel value of the image data. A determination result of the amount of light (a level of the amount of light) determined by the image processing unit 311 is sent from the communication unit 312 to the control device 32 together with the human detection information through the transmission line.

The control device 32 provides the control command so that the level of the amount of light received from the motion sensor 31 is equal to a desired value, thereby changing the dimming rate of the lighting load 33. Consequently, the amount of light in the illuminated space in which a person is present can be kept to be an appropriate amount. Note that, in a case where the amount of light in the illuminated space is excessive due to external light (e.g., daylight) entering the illuminated space via a window even when the dimming rate of the lighting load 33 is decreased down to its lower limit, the control device 32 may turn off the lighting load 33.

Note that, it is preferable that the image processing unit 311 divide the image of the detection region into a plurality of regions and determine presence or absence of persons, the number, the positions, the actions of present persons, and an amount of light for each region.

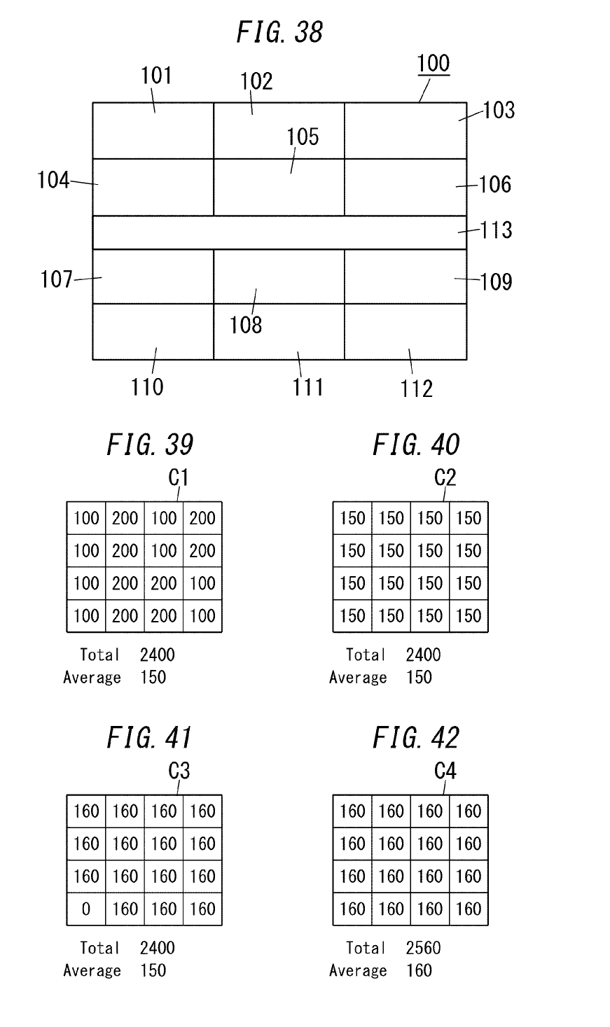

FIG. 38 shows an example of a layout of a floor of an office building selected as the illuminated space. The entire floor is selected as the detection region 100, and the center of the detection region 100 is a passageway 113 of the floor, and a plurality of (each six in the illustrated example) divided regions 101 to 112 which are separated by partitions is provided to each of both sides of the passageway 113. These plurality of (twelve in the illustrated example) divided regions 101 to 112 overlap illuminated areas of the different lighting loads 33. With regard to the motion sensor 31, the position information of the plurality of divided regions 101 to 113, for example, coordinates of four vertex of each of the divided regions 101 to 113, is inputted by the setting unit 313, and the imputed position information is stored in the storing unit 314.

The image processing unit 311 determines presence or absence of persons, the number, the locations, and the actions of present persons, and an amount of light for each of the divided regions 101 to 113 based on the position information stored in the storing unit 314, and controls the communication unit 312 to send the human detection information and the level of the amount of light of each of the divided regions 101 to 113 to the control device 32.

In summary, in the motion sensor 31 of the present embodiment, the image processing unit 311 and the setting unit 313 correspond to the determiner. However, there is no need to detect a person for all of the divided regions 101 to 113. For example, a divided region occupied by book shelves or the like may be excluded from objects to be subjected to detection of presence of a person and the like.

The control device 32 controls the lighting loads 33 associated with the divided regions 101 to 112 according to the human detection information and the levels of the amount of light with regard to the individual divided regions 101 to 113 sent from the motion sensor 31. For example, in a case where a person is present in only the divided region 101, the control device 32 provides the control command to only the lighting load 33 associated with the divided region 101 of interest, to turn on this lighting load 33 at full power. Alternatively, in a case where a person is present in only the divided region 113 corresponding to the passageway, the control device 32 provides the control command to the lighting loads 33 associated with the other divided regions 101 to 112, to turn on these lighting loads 33 at a relatively low dimming rate. Note that, an additional lighting load 33 may be installed in the passageway (the divided region 113), and the control device 32 may control the additional lighting load 33 in accordance with presence or absence of a person in the divided region 113.

As described above, the motion sensor 31 of the present embodiment includes the imager (the image sensing unit 310), the determiner (the image processing unit 311 and the setting unit 313), and (the communication unit 312). The imager (the image sensing unit 310) is configured to take an image of the detection region. The determiner (the image processing unit 311 and the setting unit 313) is configured to determine presence or absence, the number, the positions, and the actions of present persons in the detection region, from the image taken by the imager (the image sensing unit 310). The transmitter (the communication unit 312) is configured to send the determination result of the determiner (the image processing unit 311 and the setting unit 313) to the control device 32 to control the load. The determiner (the image processing unit 311 and the setting unit 313) is configured to determine presence or absence, the number, the positions, and the actions of present persons for each of the plurality of regions divided from the image of the detection region, and detect a human pixel region from a region and to determine an action of a person based on a moving distance of a representative position of the human pixel region within predetermined time.

Note that, in the motion sensor 31, with regard to the determiner (the image processing unit 311 and the setting unit 313), the number and the locations of regions in the image of the detection region, and whether to detect a person from a region may be selectable.

The load control system of the present embodiment includes the motion sensor 31, and the control device 32 configured to control one or more loads based on the determination result sent from the motion sensor 31.

Note that, in this load control system, the load may be a lighting load 33 installed in the illuminated space. The determiner (the image processing unit 311 and the setting unit 313) may determine the amount of light in the detection region from the pixel value of the image of the detection region. The transmitter (the communication unit 312) may transmit the determination result of the amount of light to the control device 32 together with the determination result of presence or absence of persons, the number, the positions, and the actions of present persons. The control device 32 may control the lighting load 33 so that the amount of light received from the motion sensor 31 is equal to the desired amount of light.

As described above, according to the motion sensor 31 and the load control system of the present embodiment, presence or absence of a person is determined based on the image of the detection region taken by the image sensing unit 310. In contrast to a conventional example of using a pyroelectric element, a person at rest can be detected. Further, it is possible to detect a person for each of the plurality of regions 101 to 113 divided from the detection region 100. In short, the motion sensor 31 and the load control system of the present embodiment can provide an effect of enabling detection of a person at rest and of detection of a person for each of the plurality of regions.

In the present embodiment, the motion sensor 31 may include a similar configuration to the object detection device 1 of the embodiment 1. The motion sensor (the object detection device) 31 of the present embodiment may include the aforementioned first feature. Further, the motion sensor 31 of the present embodiment may include the aforementioned second to thirteenth features selectively in addition to the aforementioned first feature.

Further, the image sensing unit 310 in the present embodiment may include a similar configuration to the image sensing device 10 of the embodiment 2. In other words, the motion sensor 31 of the present embodiment may include the aforementioned fourteenth to twenty-second features selectively.

Alternatively, the image sensing unit 310 in the present embodiment may include a similar configuration to the image sensing device 21 of the embodiment 3. In other words, the motion sensor 31 of the present embodiment may include the aforementioned twenty-third to thirty-second features selectively.

1. An object detection device, comprising:
an image obtainer configured to obtain, from a camera for taking images of a predetermined image sensed area, the images of the predetermined image sensed area at a predetermined time interval sequentially;
a difference image creator configured to calculate a difference image between images obtained sequentially by the image obtainer; and
a determiner configured to determine whether each of a plurality of blocks obtained by dividing the difference image in a horizontal direction and a vertical direction is a motion region in which a detection target in motion is present or a rest region in which an object at rest is present,
the determiner being configured to determine, with regard to each of the plurality of blocks, whether a block is the motion region or the rest region, based on pixel values of a plurality of pixels constituting this block.

2. The object detection device according to claim 1, wherein
the determiner is configured to compare, with regard to each of the plurality of blocks, difference values of pixels constituting a block with a predetermined threshold, and determine whether this block is the motion region or the rest region, based on the number of pixels whose difference values exceed the predetermined threshold.

3. The object detection device according to claim 1, further comprising an object detector configured to detect a detection target from a region determined as the motion region,
the object detector being configured to determine, as a detection target region, each of consecutive blocks of one or more blocks determined as the motion region,
the object detector being configured to,
when a currently obtained detection target region is included in a previously obtained detection target region,
or when the currently obtained detection target region and the previously obtained detection target region overlap each other and a ratio of an area of the currently obtained detection target region to an area of the previously obtained detection target region is smaller than a predetermined threshold,
or when there is no overlap between the currently obtained detection target region and the previously obtained detection target region,
determine that the detection target is at rest and then regard the previously obtained detection target region as a region in which the detection target is present.

4. The object detection device according to claim 3, wherein:
the object detector is configured to, when the currently obtained detection target region and the previously obtained detection target region overlap each other, determine that the same detection target is present in the currently obtained detection target region and the previously obtained detection target region; and
the object detector is configured to change a determination condition for determining a current location of the detection target from the currently obtained detection target region and the previously obtained detection target region, in accordance with whether the detection target present in the previously obtained detection target region is at rest, or a parameter indicative of a movement of the detection target when it is determined that the detection target is not at rest.

5. The object detection device according to claim 3, wherein
the object detector is configured to, when a previous first detection target region and a current detection target region overlap each other but there is no overlap between the current detection target region and a previous second detection target region, determine that a detection target present in the first detection target region has moved to the current detection target region.

6. The object detection device according to claim 3, wherein
the object detector is configured to, when a current detection target region overlaps a previous first detection target region and a previous second detection target region and it is determined that a detection target present in the first detection target region is at rest, determine that the detection target present in the first detection target region stays in the first detection target region.

7. The object detection device according to claim 3, wherein:
the object detector is configured to, when a current detection target region overlaps a previous first detection target region and a previous second detection target region and it is determined that both a first detection target present in the first detection target region and a second detection target present in the second detection target region are in motion and when a speed of the first detection target is more than a speed of the second detection target, determine that the first detection target has moved to the current detection target region; and
the object detector is configured to, when a current detection target region overlaps a previous first detection target region and a previous second detection target region and it is determined that both a first detection target present in the first detection target region and a second detection target present in the second detection target region are in motion and when a speed of the first detection target is equal to or less than a speed of the second detection target, determine that the first detection target has remained in the first detection target region.

8. The object detection device according to claim 3, wherein
the object detector is configured to, when a current detection target region overlaps a previous first detection target region and a previous second detection target region and it is determined that a first detection target present in the first detection target region is in motion and a second detection target present in the second detection target region is at rest, determine that the first detection target has moved to the current detection target region.

9. The object detection device according to claim 3, wherein:
the object detector is configured to, when it is determined that a detection target present in a first detection target region obtained at a certain timing is at rest and at least part of a second detection target region obtained after the certain timing overlaps the first detection target region, store, as a template image, an image of the first detection target region obtained immediately before overlapping of the second detection target region;
the object detector is configured to, at a timing when an overlap between the first detection target region and the second detection target region disappears, perform a matching process between an image of the first detection target region at this timing and the template image to calculate a correlation value between them;
the object detector is configured to, when the correlation value is larger than a predetermined determination value, determine that the detection target has remained in the first detection target region; and
the object detector is configured to, when the correlation value is smaller than the determination value, determine that the detection target has moved outside the first detection target region.

10. The object detection device according to claim 1, further comprising an image sensing device serving as the camera,
the image sensing device including:
an image sensor which includes a plurality of pixels each to store electric charges and is configured to convert amounts of electric charges stored in the plurality of pixels into pixel values and output the pixel values;
a light controller configured to control an amount of light to be subjected to photoelectric conversion by the image sensor;
an image generator configured to read out the pixel values from the image sensor at a predetermined frame rate and generate an image at the frame rate from the read-out pixel values; and
an adjuster configured to evaluate some or all of the pixel values of the image generated at the frame rate by an evaluation value defined as a numerical value and adjust the pixel values by controlling at least one of the light controller and the image generator so that the evaluation value falls within a predetermined appropriate range, and
the adjuster being configured to, when the evaluation value of the image generated at the frame rate is deviated from the appropriate range by a predetermined level or more, set the image generator to an adjusting mode of generating an image at an adjustment frame rate higher than the frame rate, and after the image generator generates the image at the adjustment frame rate, set the image generator to a normal mode of generating the image at the frame rate.

11. The object detection device according to claim 1, further comprising an image sensing device serving as the camera,
the image sensing device includes:
an image sensing unit configured to take an image of an image sensed area at a predetermined frame rate;
an exposure adjuster configured to adjust an exposure condition for the image sensing unit;
an amplifier configured to amplify luminance values of individual pixels of image data outputted from the image sensing unit and output the resultant luminance values; and
a controller configured to adjust at least one of the exposure condition of the exposure adjuster and an amplification factor of the amplifier so that a luminance evaluation value calculated by statistical processing on the luminance values of the individual pixels of the image data is equal to a predetermined intended value, and
the controller being configured to, when the luminance evaluation value falls within a luminance range in which image processing on image data outputted from the amplifier is possible, limit an amount of adjustment so that a ratio of change in the luminance evaluation value caused by adjustment of at least one of the exposure condition and the amplification factor is equal to or less than a predetermined reference value, and being configured to, when the luminance evaluation value is out of the luminance range, not limit the amount of adjustment.
